(19) United States
(12) Patent Application Publication
(10) Pub. No.: US 2009/0088308 A1
(43) Pub. Date: Apr. 2, 2009

(54) SHEET PROCESSING APPARATUS, SHEET PROCESSING METHOD AND IMAGE FORMING APPARATUS

(75) Inventors: Yusuke Obuchi, Abiko-shi (JP); Kiyoshi Watanabe, Matsudo-shi (JP); Ken-ichi Tamura, Toride-shi (JP); Daisaku Kamiya, Abiko-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/233,578

(22) Filed: Sep. 18, 2008

(30) Foreign Application Priority Data
Sep. 28, 2007 (JP) 2007-253574

(51) Int. Cl. B31B 19/02

(52) U.S. Cl. 493/186

(57) ABSTRACT

The present invention provides a sheet processing apparatus and an image forming apparatus, in which sheet information can be easily and surely be concealed without damaging a sheet S. After a wrapping portion 500A wraps the sheet with a magnet sheet MS while the magnet sheet MS is folded into two by a pressing force of the sheet, a discharge portion discharges the magnet sheet MS with which the sheet S is wrapped. Therefore, the sheet information can be easily and surely be concealed without damaging the sheet S.

### BACKGROUND OF THE INVENTION

1. Field of the Invention

The present invention relates to a sheet processing apparatus, sheet processing method and an image forming apparatus, particularly to a configuration in which a sheet bundle is bound.

2. Description of the Related Art

Conventionally, in some cases, an image forming apparatus such as a copying machine, a printer, a facsimile and a multi function peripheral thereof includes a sheet processing apparatus. In the sheet processing apparatus, sheets in which images are formed are temporarily stored and aligned to form a sheet bundle, and a binding process is performed to the sheet bundle while a saddle stitching process and a half-folding process are combined.

In the conventional sheet processing apparatus, in binding the sheets, the sheet discharged from the image forming apparatus is delivered to an abutting portion, and the sheets are temporarily stored in the abutting portion by repeating the delivery operation.

Then, the sheets stored in the abutting portion are aligned with an aligning member, and a substantial center portion of the aligned sheet bundle is bound with a staple needle. The sheet bundle bound with the staple needle is folded into two such that a binding position of the sheet bundle becomes a folding position. Therefore, the half-folded sheet bundle in which the saddle stitching is performed is obtained as an output.

Recently, the image forming apparatus provided with the sheet processing apparatus is frequently connected to a network so as to be shared by plural persons. In such cases, each operator performs output manipulation some where away from the image forming apparatus, and the operator picks up the output to the image forming apparatus or sheet processing apparatus when the output is finished.

Thus, in the case of the image forming apparatus connected to the network, the image forming apparatus is shared by plural persons, and each operator performs the output manipulation some where away from the image forming apparatus. Therefore, another operator can easily see contents of the output, which causes a problem of information masking during output of important information.

Therefore, for example, Japanese Patent Application Laid-Open Nos. 2001-58758, 9-188471, and disclose a technique in which an end portion is bound with the staple needle to prevent a third person from seeing the output information. Japanese Patent Application Laid-Open No. 2004-90401 discloses a technique in which a thermoplastic resin is applied to the end portion of the output and a separate sheet member is thermally welded to conceal information. There is also disclosed a technique of clipping the sheet bundle.

In the conventional sheet processing apparatus disclosed in Japanese Patent Application Laid-Open Nos. 2001-58758, 9-188471, and 11-060042, when the sheets are bound with the staple needle, it is necessary that the staple needle on an opening portion of the sheet bundle be removed in order to be able to browse contents of the sheet bundle.

However, it is necessary that the staple needle be carefully removed so as not to damage the sheet bundle, which generates a troublesome task. Even if the staple needle is removed without damaging the sheet bundle, a trace of the staple needle remains on the opening portion sides of all the sheets of the sheet bundle. Therefore, even if the information masking can be achieved, the finally-obtained sheet bundle does not have a good state.

In the case where the thermoplastic resin is applied to the sheet bundle as disclosed in Japanese Patent Application Laid-Open No. 2004-90401, unfortunately the sheet is hardly reused. The information cannot be written in the portion where the thermoplastic resin is applied, which causes a problem in that another sheet is required to conceal the information in a sheet surface.

In the case where the sheet bundle is clipped, the document easily comes apart because of a weak clipping force. In the case where a leaf-spring type clip is used to enhance the clipping force, the clipping trace remains in the sheet to damage the sheet.

The present invention provides a sheet processing apparatus and an image forming apparatus, in which the sheet information can be concealed easily and surely without damaging the sheet.

### SUMMARY OF THE INVENTION

In a sheet processing apparatus which performs a process for wrapping around a sheet with a magnet sheet having a magnetic force, the sheet processing apparatus includes a wrapping portion which wraps the sheet by bonding the magnet sheet by the magnetic force; and a discharge portion which discharges the magnet sheet while the sheet is wrapped.

In an image forming apparatus provided with a sheet processing apparatus which processes a sheet, the sheet processing apparatus includes a folding member which folds a magnet sheet such that an imageable first plane faces inward, an image being formed in the first face in the magnet sheet.

Accordingly, the sheet is wrapped by the magnet sheets, which allows the sheet information to be concealed easily and surely without damaging the sheet. Additionally, the magnet sheet in which the image is formed in the first plane is folded such that the first plane faces inward, which allows the sheet information to be concealed easily and surely without damaging the sheet.

Further features of the present invention will become apparent from the following description of exemplary embodiments with reference to the attached drawings.

### BRIEF DESCRIPTION OF THE DRAWINGS

FIG. 1 illustrates a configuration of an image forming apparatus provided with a sheet processing apparatus according to a first embodiment of the invention.

FIG. 2 illustrates a magnet sheet used in the sheet processing apparatus of the first embodiment.

FIGS. 3A and 3B are first views explaining an operation for wrapping a sheet bundle of the sheet processing apparatus with one magnet sheet.

FIG. 4 is a second view explaining an operation for wrapping a sheet bundle of the sheet processing apparatus with one magnet sheet.

FIG. 5 illustrates a state in which the sheet bundle is wrapped with the one magnet sheet.

FIGS. 6A and 6B are first views explaining an operation for wrapping a sheet bundle of the sheet processing apparatus with two magnet sheets.

FIG. 7 is a second view explaining an operation for wrapping a sheet bundle of the sheet processing apparatus with two magnet sheets.

FIG. 8 is a control block diagram illustrating the image forming apparatus of the first embodiment.

FIG. 9 is a flowchart explaining an operation for selecting a method of wrapping a sheet bundle of the sheet processing apparatus.

FIGS. 10A and 10B are views explaining a magnet sheet used in a sheet processing apparatus according to a second embodiment of the invention.

FIG. 11A illustrates a state in which a sheet bundle is placed on a back surface of the magnet sheet, FIG. 11B illustrates a state in which the magnet sheet is folded into two such that the back surface faces inward while the sheet bundle is wrapped, and FIG. 11C illustrates a section of the state in which the sheet bundle is wrapped.

FIGS. 12A and 12B are views explaining another configuration of the magnet sheet used in the sheet processing apparatus of the second embodiment.

FIG. 13A illustrates a state in which a sheet bundle is placed on a back surface of the magnet sheet, FIG. 13B illustrates a state in which the magnet sheet is folded into two such that the back surface faces inward while the sheet bundle is wrapped, and FIG. 13C illustrates a section of the state in which the sheet bundle is wrapped.

FIGS. 14A and 14B are views explaining a configuration of a wrapping tool in which the magnet sheet is used, the wrapping tool being used in the sheet processing apparatus of the second embodiment.

FIG. 15A illustrates a state in which a sheet bundle is placed on a backside of the wrapping tool, FIG. 15B illustrates a state in which the wrapping tool is folded into two while the sheet bundle is wrapped, and FIG. 15C illustrates a section of the state in which the sheet bundle is wrapped.

FIG. 16 illustrates a configuration of an image forming apparatus according to a third embodiment of the invention.

FIG. 17 is a perspective view illustrating a magnet sheet used in the image forming apparatus of the third embodiment.

FIG. 18 is a flowchart illustrating control in a security process of the image forming apparatus of the third embodiment.

FIG. 19A is a perspective view illustrating the magnet sheet which is folded by a finisher provided in the image forming apparatus of the third embodiment, and FIG. 19B is a perspective view illustrating a normal sheet which is folded by a finisher provided in the image forming apparatus of the third embodiment.

FIG. 20 is a perspective view illustrating a state in which the magnet sheet folded by the finisher is opened.

FIG. 21 illustrates a configuration of a sheet processing apparatus according to a fourth embodiment of the invention.

FIGS. 22A and 22B are views explaining a magnet sheet used in the sheet processing apparatus of the fourth embodiment.

FIGS. 23A and 23B are views explaining an operation for obliquely folding the magnet sheet used in the sheet processing apparatus of the fourth embodiment.

FIG. 24 is a control block diagram illustrating an image forming apparatus provided with the sheet processing apparatus of the fourth embodiment.

FIG. 25 is a flowchart illustrating an operation for folding one magnet sheet into two to wrap a sheet in which an image is formed therebetween in the sheet processing apparatus of the fourth embodiment.

FIGS. 26A and 26B are first views illustrating an operation for folding one magnet sheet into two to wrap a sheet in which an image is formed therebetween in the sheet processing apparatus of the fourth embodiment.

FIG. 27 is a second view illustrating an operation for folding one magnet sheet into two to wrap a sheet in which an image is formed therebetween in the sheet processing apparatus of the fourth embodiment.

FIGS. 28A and 28B illustrate a configuration in which a sheet in which an image is formed is wrapped between two magnet sheets in the sheet processing apparatus of the fourth embodiment.

FIGS. 29A and 29B illustrate a configuration in which a sheet in which an image is formed is wrapped between two oblique magnet sheets in the sheet processing apparatus of the fourth embodiment.

FIGS. 30A and 30B are first views explaining an operation for wrapping a sheet in which an image is formed between two magnet sheets in the sheet processing apparatus of the fourth embodiment.

FIGS. 31A and 31B are second views explaining an operation for wrapping a sheet in which an image is formed between two magnet sheets in the sheet processing apparatus of the fourth embodiment.

FIGS. 32A and 32B are third views explaining an operation for wrapping a sheet in which an image is formed between two magnet sheets in the sheet processing apparatus of the fourth embodiment.

FIGS. 33A and 33B are views explaining another configuration of a magnet sheet used in the sheet processing apparatus of the fourth embodiment.

FIGS. 34A to 30C illustrate a state in which a sheet bundle is wrapped with the magnet sheet.

FIGS. 35A and 35B are views explaining an operation for wrapping a sheet bundle is wrapped with the magnet sheet.

### DESCRIPTION OF THE EMBODIMENTS

An exemplary embodiment of the invention will be described below with reference to the drawings.

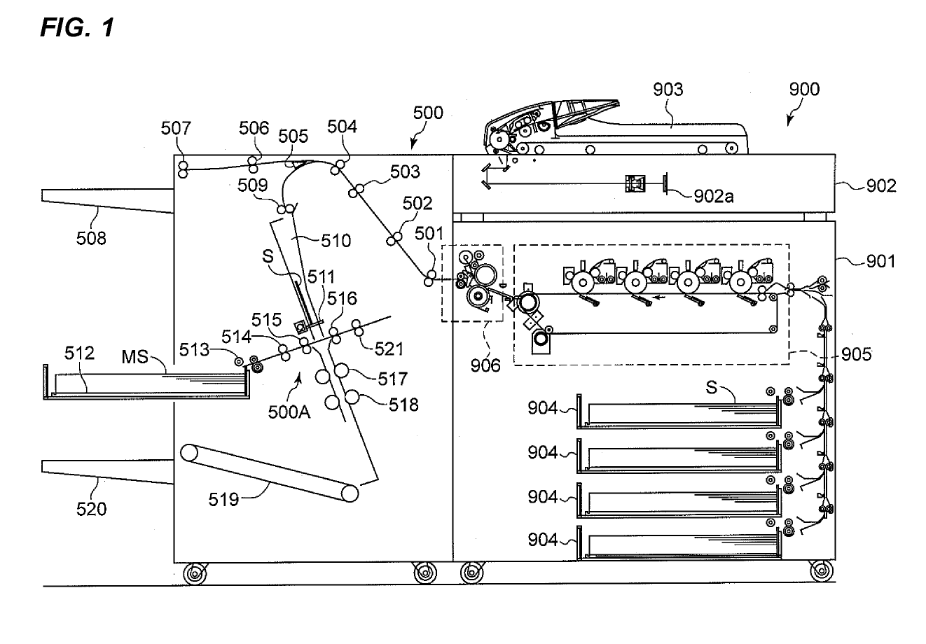

FIG. 1 illustrates a configuration of an image forming apparatus provided with a sheet processing apparatus according to a first embodiment of the invention.

Referring to FIG. 1, an image forming apparatus 900 includes an image forming apparatus main body 901, an original reading portion (image reader) 902 which is provided in an upper portion of the image forming apparatus main body 901, and an automatic original conveying apparatus 903 which automatically reads plural originals.

The image forming apparatus main body 901 includes a sheet feed cassette 904, an image forming portion 905, and a fixing portion 906. A normal sheet S is stacked on the sheet feed cassette 904 in order to form the image. The image forming portion 905 forms a toner image on the sheet through an electrophotographic process. The fixing portion 906 fixes the toner image formed on the sheet. A finisher 500 which is of a sheet processing apparatus is connected to the image forming apparatus main body 901.

In the image forming apparatus 900, in forming an image of an original (not shown) on the sheet, an image sensor 902a of the original reading portion 902 reads the image of the original conveyed by the automatic original conveying apparatus 903. Then, the image forming portion 905 forms the toner image according to information on the read image, and the toner image is transferred onto the sheet. Then, the toner image transferred onto the sheet is permanently fixed by the fixing portion 906. After the toner image is fixed, the sheet is conveyed to the finisher 500 in order to perform a process to the sheet.

In the finisher 500, the sheets discharged from the image forming apparatus main body 901 are sequentially taken in, the plural sheets are aligned to form one bundle, and the sheet bundle is wrapped around to conceal sheet bundle information.

In the first embodiment, the sheet bundle is wrapped around (sandwiched) to conceal the sheet bundle information by a magnet sheet MS. Therefore, the finisher 500 includes a wrapping portion 500A, and the wrapping portion 500A wraps the sheet bundle by bonding the magnet sheet MS by a magnetic force such that the sheet bundle information is concealed.

The wrapping portion 500A includes a processing tray 510 and a sheet tray 512. The processing tray 510 aligns the plural sheets discharged from the image forming apparatus main body 901, and the processing tray 510 bundles the plural sheets. The plural magnet sheets MS are stacked on the sheet tray 512.

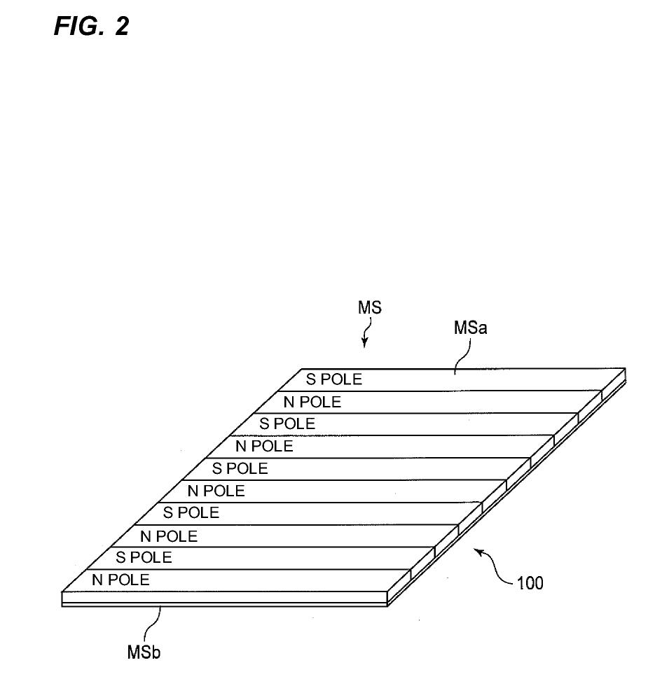

As shown in FIG. 2, a magnet portion MSa in which magnetic powders are mixed in a resin binder and a paper portion MSb in which the image is formed are glues together in the magnet sheet MS. In a magnetic pattern of the magnet portion MSa, N poles and S poles are alternately magnetized at predetermined intervals, and a magnetic field line is generated only in an opposite plane to a plane glued to the paper portion MSb. The magnet sheet MS is placed on the sheet tray 512 such that an upper front surface of the magnet sheet MS is orientated toward the magnet portion MSa.

As shown in FIG. 1, the finisher 500 includes a pair of entrance rollers 501 which guides the sheet discharged from the image forming apparatus main body 901 to the inside of the finisher. When the sheet is discharged from the image forming apparatus main body 901, the pair of entrance rollers 501 of the finisher 500 conveys the sheet to the inside of the finisher.

At this point, in the case where no process is performed to the sheet, the pairs of conveying rollers 502 to 504 convey the sheet S. Then, a switching member 505 is driven clockwise by driving means such as a solenoid (not shown), whereby the sheet S is discharged to an upper tray 508 by a pair of conveying rollers 506 and a pair of sheet discharge rollers 507.

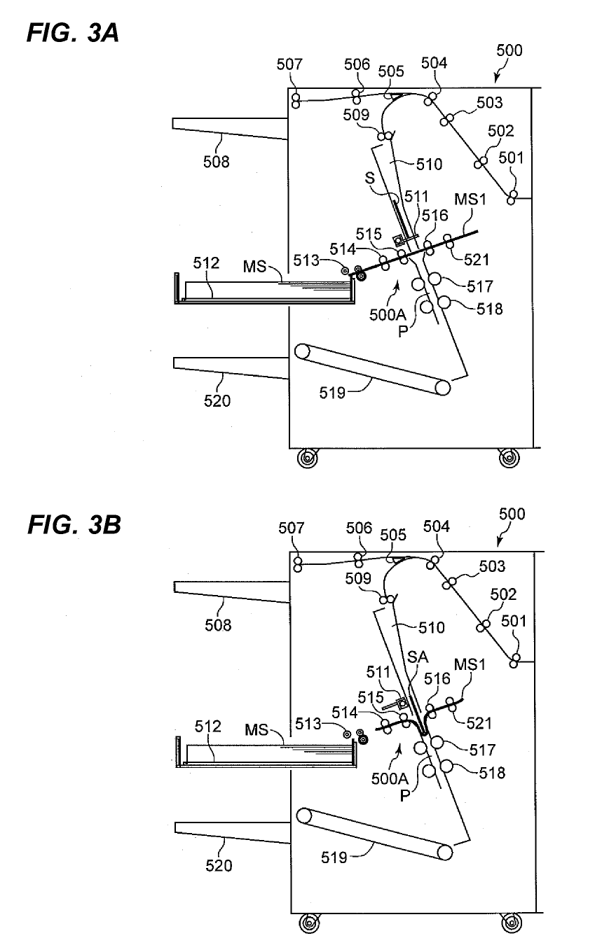

On the other hand, in the case where the information on the sheet is concealed, as shown in FIG. 3A, the sheet S conveyed to the pair of conveying rollers 504 is guided to a pair of conveying rollers 509 by switching the switching member 505, and the sheet S is discharged to the processing tray 510.

A forefront stopper 511 which is of a support member for supporting the sheet is provided in a lower end portion of the processing tray 510, and a forefront of the sheet S abuts on the forefront stopper 511 to be sequentially stored in the processing tray. The forefront stopper 511 can be turned downward. When a predetermined number of sheets S are stored in the processing tray 510, the forefront stopper 511 is turned downward, whereby the sheet bundle stored with the forefront abutting on the forefront stopper 511 drops downward.

While the sheets S are stacked on the processing tray 510, the uppermost magnet sheet MS1 of the magnet sheets MS stored in the sheet tray 512 is fed by a sheet feed roller 513.

The magnet sheet MS1 fed by the sheet feed roller 513 is conveyed below the forefront stopper 511 by pairs of conveying rollers 514 to 516 and 521. The pairs of conveying rollers 514 to 516 and 521 are of the sheet conveying member which conveys the magnet sheet to a position below the sheet. The magnet sheet MS1 is stopped when the pairs of conveying rollers 514 to 516 and 521 convey the magnet sheet MS1 to a position where a substantial center in a conveying direction of the magnet sheet MS1 faces the sheet bundle.

Then, when the number of sheets constituting the sheet bundle reaches the predetermined number of sheets, the forefront stopper 511 is turned downward as described above, which allows the end portion of the sheet bundle to drop onto the central portion of the magnet sheet MS1. Therefore, as shown in FIG. 3B, the end portion of a sheet bundle SA abuts on the magnet sheet MS1, the sheet bundle SA drops while folding the magnet sheet MS1 into two from the center, thereby wrapping around (sandwiching) the sheet bundle SA by the half-folded magnet sheet MS1.

When the magnet sheet MS1 is folded into two from the center, the insides of the magnet sheet MS1 are magnetically joined, thereby wrapping around (sandwiching) the sheet bundle SA by the half-folded magnet sheet MS1.

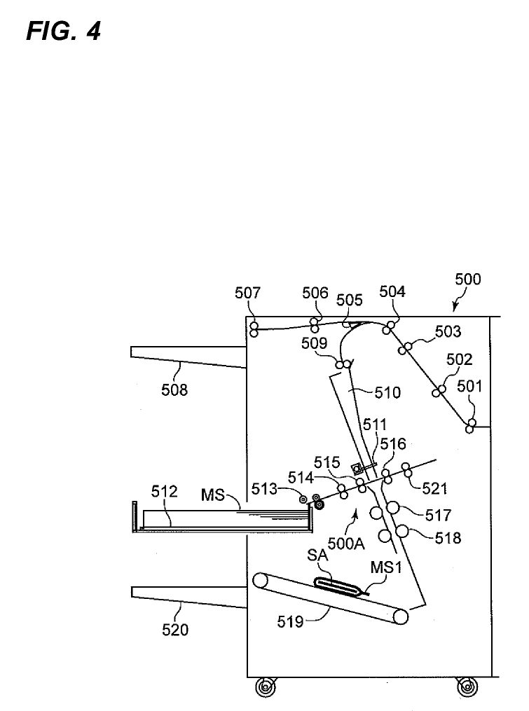

The sheet bundle SA wrapped by the magnet sheet MS1 is guided to a belt conveying portion 519 constituting a discharge portion by pairs of conveying rollers 517 and 518. The pairs of conveying rollers 517 and 518 are provided in a conveying path P disposed below the processing tray 510. Then, as shown in FIG. 4, the belt conveying portion 519 discharges and stacks the sheet bundle SA wrapped by the magnet sheet MS1 onto a lower tray 520.

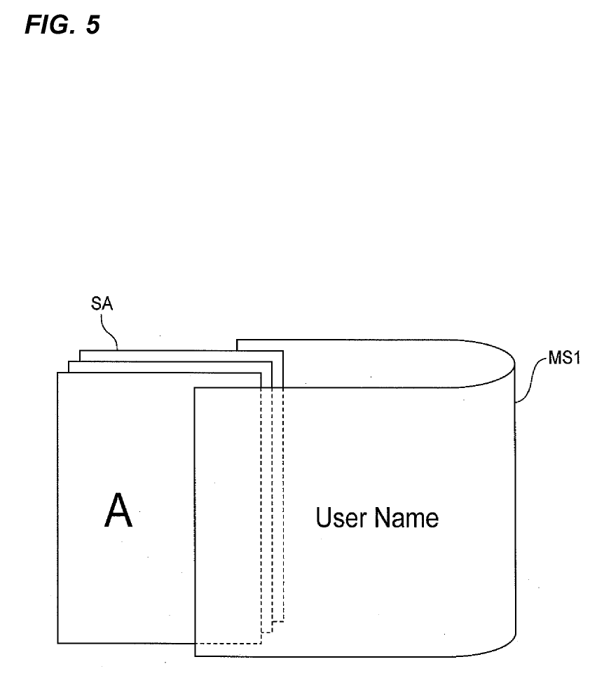

Thus, the sheet bundle SA wrapped by the magnet sheet MS1 is formed by performing the above-described process as shown in FIG. 5. As long as the magnet sheet MS1 is intentionally taken out from the sheet bundle SA, the security is maintained because the image formed on the sheet S is hardly read.

In the magnet sheet MS1, an identification mark for identifying the sheet may be formed on an opposite (outside) surface to the surface on the side (inside) where the sheet bundle SA is wrapped around (sandwiched). The identification mark (such as a name and a symbol) described in the front surface of the magnet sheet MS1 facilitates the identification of the sheet bundle SA.

Although the sheet bundle SA is wrapped by the half-folded magnet sheet MS1 in the above description, the sheet bundle may be wrapped (sandwiched) with two (plural) magnet sheets.

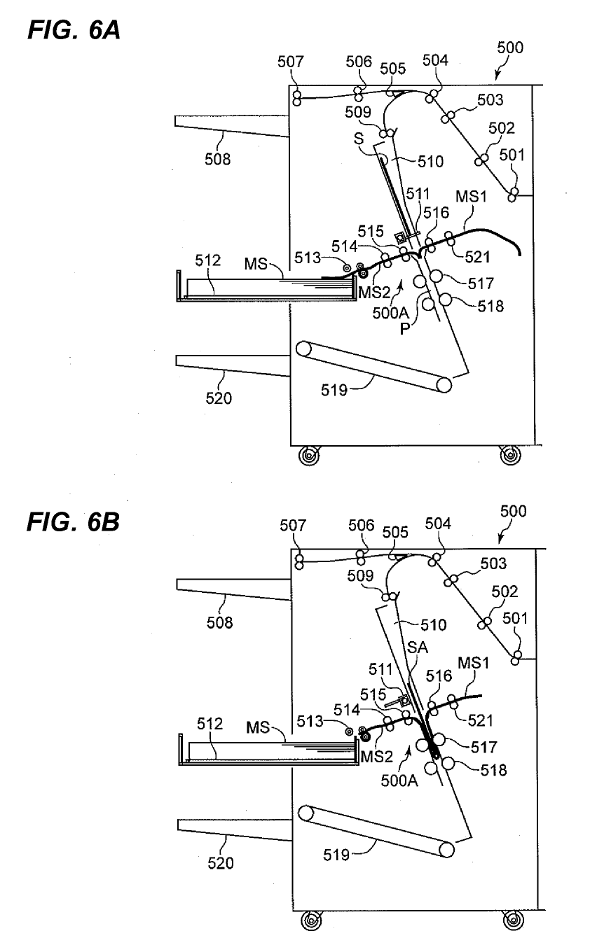

In such cases, as shown in FIG. 6A, while the sheets S are stacked on the processing tray 510, the magnet sheet MS1 on the sheet tray is fed by the sheet feed roller 513, and the magnet sheet MS1 is conveyed by the pairs of conveying rollers 514 to 516. When a back end portion of the magnet sheet MS1 is conveyed to the substantial center of the conveying path P, the conveyance of the magnet sheet MS1 is stopped and the next magnet sheet MS2 is fed by the sheet feed roller 513.

The pairs of conveying rollers 514 and 515 convey the next magnet sheet MS2, and the pairs of conveying rollers 521 and 516 which wrap the magnet sheet MS1 are reversely rotated at a time the forefront of the next magnet sheet MS2 reaches the substantial center of the conveying path P. Therefore, the back end of the uppermost magnet sheet MS1 is aligned with the forefront portion of the next magnet sheet MS2, and the two magnet sheets MS1 and MS2 are joined (connected) by the magnetic force.

At this point, because the back end of the uppermost magnet sheet MS1 and the forefront portion of the next magnet sheet MS2 are bent downward by weights thereof, a joining portion between the uppermost magnet sheet MS1 and the next magnet sheet MS2 are bent downward.

Then, as shown in FIG. 6B, the sheet bundle reaches the predetermined number of sheets, the forefront stopper 511 is turned downward as described above, whereby the end portion of the sheet bundle SA drops onto the joining portion between the two magnet sheets MS1 and MS2. Therefore, the end portion of the sheet bundle SA drops while downwardly compressing the joining portion between the two magnet sheets MS1 and MS2, thereby wrapping around (sandwiched) the sheet bundle SA between the two magnet sheets MS1 and MS2.

When the two magnet sheets MS1 and MS2 drops while the joining portion is orientated downward, the insides of the insides of the two magnet sheets MS1 and MS2 are magnetically joined, and therefore the sheet bundle Sa is wrapped (sandwiched) between the two magnet sheets MS1 and MS2.

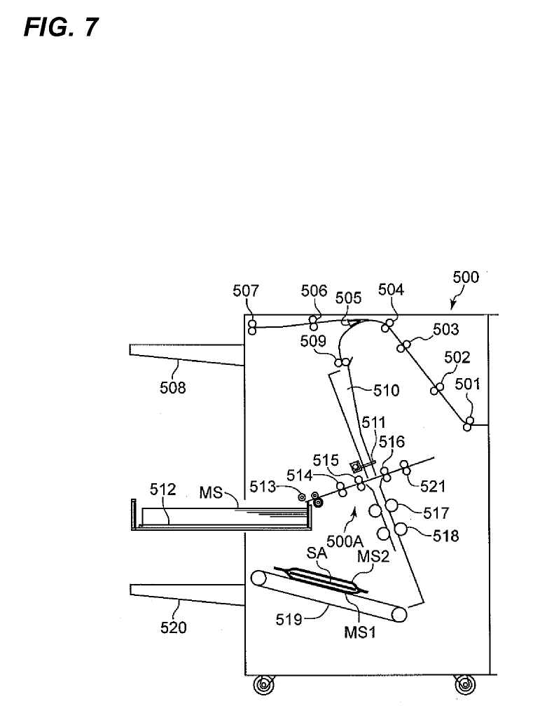

The sheet bundle wrapped between the two magnet sheets MS1 and MS2 is guided to the belt conveying member 519 by the pairs of conveying rollers 517 and 518 provided in the conveying path P. Then, as shown in FIG. 7, the sheet bundle wrapped between the two magnet sheets MS1 and MS2 is discharged and stacked on the lower tray 520 by the belt conveying member 519.

Thus, the sheet bundle wrapped between the two magnet sheets MS1 and MS2 is formed. As long as the sheet bundle SA is intentionally taken out from the magnet sheets MS1 and MS2, the security is maintained because the image formed on the sheet bundle SA is hardly read. In this case, similarly the identification mark (such as a name and a symbol) described in the surfaces of the magnet sheets MS1 and MS2 facilitates the identification of the sheet bundle SA.

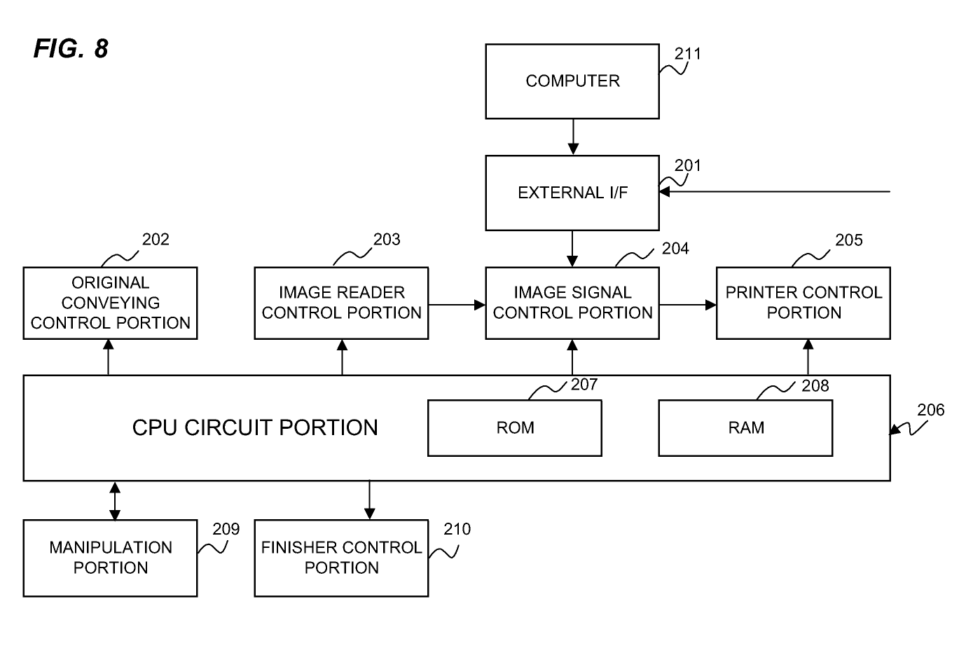

FIG. 8 is a control block diagram of the image forming apparatus 900. A CPU circuit portion 206 includes ROM 207 and RAM 208. A control program and the like are stored in ROM 207, and RAM 208 is used as an area where control data is tentatively retained or a work area for computation associated with control.

In FIG. 8, an external I/F 201 is an interface between the image forming apparatus 900 and the external computer 211. When the external I/F 201 receives print data from the computer 211, the external I/F 201 expands the print data into bitmap image, and the external I/F 201 supplies the bitmap image as image data to an image signal control portion 204.

The image signal control portion 204 supplies the image data to a printer control unit 205, and the printer control unit 205 supplies the image data supplied from the image signal control portion 204 to an exposure controlling portion (not shown). The image reader control portion 203 supplies the image of the original read by the image sensor 902a (see FIG. 1) to the image signal control portion 204, and the image signal control portion 204 supplies the image output to the printer control unit 205.

A manipulation portion 209 includes plural keys for setting various functions relating to the image formation and a display portion for displaying the setting states. The manipulation portion 209 supplies a key signal corresponding to each key manipulation performed by a user to the CPU circuit portion 206, and the manipulation portion 209 displays information corresponding to a signal from the CPU circuit portion 206 on the display portion.

The CPU circuit portion 206 controls the image signal control portion 204 according to the control program stored in ROM 207 and the setting of the manipulation portion 209, and the CPU circuit portion 206 controls the automatic original conveying apparatus 903 through an original conveying control portion 202.

The CPU circuit portion 206 controls the image reader 902 through the image reader control portion 203, and the CPU circuit portion 206 controls the image forming portion 905 through the printer control unit 205. The CPU circuit portion 206 controls the wrapping portion 500A provided in the finisher 500 through a finisher control portion 210, and the CPU circuit portion 206 controls the operation for wrapping around (sandwiching) the sheet bundle by the magnet sheet.

The CPU circuit portion 206 controls the finisher control portion 210 of the finisher 500 on the basis of the process mode fed from and set by the computer 211 or manipulation portion 209.

The two kinds of the methods for wrapping around the sheets in which the images are formed by one or two magnet sheets are described above. In the first embodiment, the two kinds of the methods can be selected according to the sheet size or the number of sheets of the sheet bundle.

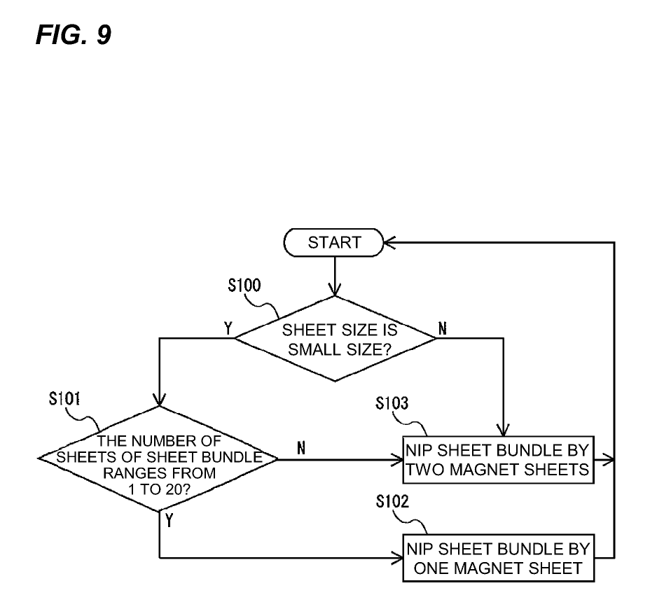

An operation for selecting the method of wrapping around the sheet bundle will be described with reference to a flowchart of FIG. 9.

When the user supplies the size of the sheet in which the image is formed and the number of sheets to the CPU circuit portion 206 through the manipulation portion 209, the CPU circuit portion 206 previously notifies the finisher control portion 210 of the size of the sheet in which the image is formed and the number of sheets.

In the case where the sheet size is a small size (such as B5, A4, and LTR) (Y in S100), the finisher control portion 210 determines whether or not the number of sheets of the sheet bundle ranges from 1 to 20 (S101). When the number of sheets of the sheet bundle ranges from 1 to 20 (Y in S101), the operation for wrapping around the sheet while folding the one magnet sheet by the pressing force of the wrapped sheet is selected (S102).

When the number of sheets of the sheet bundle exceeds 20 (N in S101), the operation for wrapping around the sheet bundle while folding the joining portion of the two (or at least two) magnet sheets by the pressing force of the wrapped sheet is selected (S103). In the case where the sheet size is a large size (B4 size or more) (N in S100), the operation for wrapping around the sheet bundle while folding the joining portion of the two (or at least two) magnet sheets by the pressing force of the wrapped sheet is selected (S103).

The sheet can effectively be wrapped by appropriately selecting the methods of wrapping around the sheet bundle according to the sheet size information and the information on the number of sheets from the manipulation portion 209 which is of the input portion.

In the case where the method of wrapping around the sheet bundle is selected, the threshold may appropriately be changed according to the sizes of the wrapping magnet sheet and wrapped sheet bundle. The methods of wrapping the sheet bundle may separately be used according to at least one of the sheet size information and the information on the number of sheets from the manipulation portion 209.

As described above, in the first embodiment, the sheet bundle is wrapped by the one magnet sheet while the one magnet sheet is folded into two by the sheet bundle, or the sheet bundle is wrapped by the plural magnetically-joined magnet sheets, so that the sheet information can easily be concealed without damaging the sheet.

That is, the sheet (bundle) is wrapped by at least one magnet sheet, whereby a third person can hardly see the sheet information. Because no process is performed to the wrapped sheet, the security can be ensured while the sheet bundle is maintained at a high-quality state.

Because the magnet sheet can be reused, the magnet sheet can be used as a cover member which repeatedly wraps around the sheet bundle. The methods of wrapping around the sheet bundle are selected according to the sheet size information and the information on the number of sheets, which allows the wrapping to be stably performed.

In the first embodiment, the method of wrapping around the whole region of the sheet bundle is described. However, it is not necessary to conceal the portion such as the neighborhood of the sheet end portion in which the image information is not written. Therefore, the similar effect can be obtained by the configuration in which only the necessary portion of the sheet is wrapped. Although the magnet sheet whose one side is made of the paper in the first embodiment, the similar effect can be obtained with the magnet sheet whose one side is not made of the paper.

In wrapping around the sheet by the magnet sheet, when a finger hook is not provided in the end portion of the magnet sheet, it is necessary to tear off the joining portion of the magnet sheet, and sometimes the magnet sheet is hardly opened. In such cases, the sheet bundle is wrapped while the end portions of the magnet sheet are shifted from each other, thereby improving the operability.

A second embodiment of the invention, in which the operability is improved by shifting the end portions of the magnet sheet from each other, will be described below.

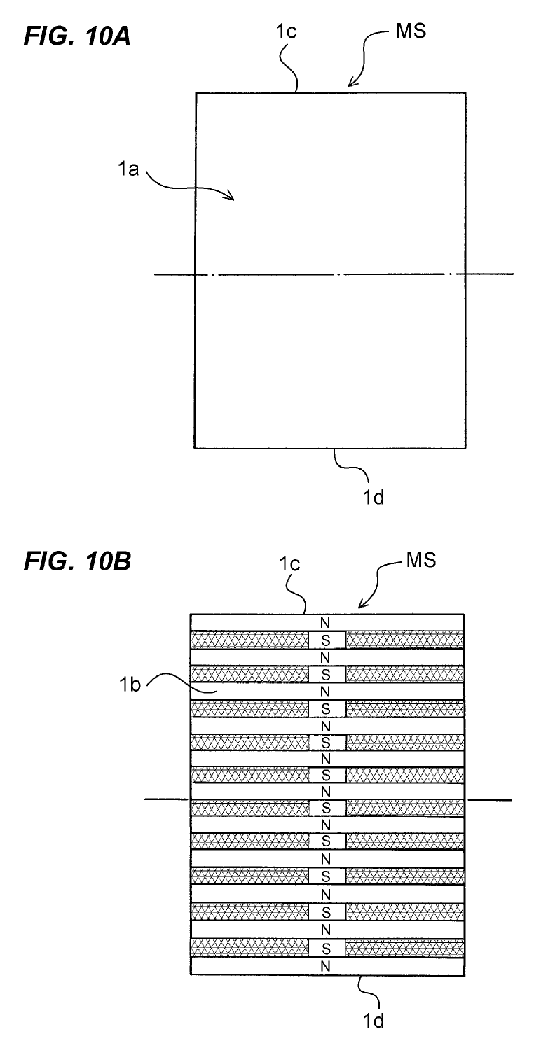

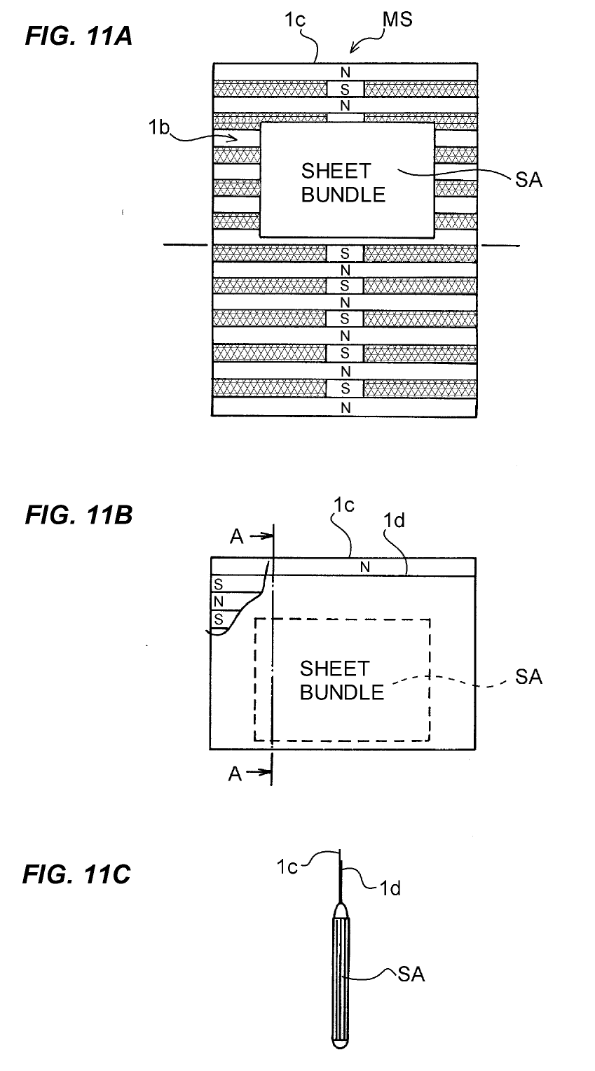

FIG. 10 is a view explaining the magnet sheet used in a sheet processing apparatus of the second embodiment, FIG. 11A illustrates a front surface 1a of the magnet sheet MS, and FIG. 10B illustrates a back surface 1b.

In the back surface 1b of the magnet sheet MS, the N poles and the S poles are alternately magnetized, and end portions 1c and 1d in folding direction with respect to the folding portion in the center of the magnet sheet are magnetized in the N pole. The pattern in which the end portions 1c and 1d are magnetized in the S pole may be adopted.

FIG. 11A illustrates a state in which the sheet bundle SA is placed on the back surface 1b of the magnet sheet MS. FIG. 11B illustrates a state in which the magnet sheet MS is folded into two such that the back surface 1b faces inward while the sheet bundle SA is wrapped, and FIG. 11C illustrates a section of the state in which the sheet bundle SA is wrapped.

Both the end portions 1c and 1d of the sheet in the back surface 1b of the magnet sheet MS are magnetized in the N pole. Therefore, in the case where the magnet sheet MS is folded into two such that the back surface 1b faces inward, as shown in FIGS. 11B and 11C, the end portions 1c and 1d of the magnet sheet MS are magnetically repelled, the end portions 1c and 1d are not aligned with each other, and the portions 1c and 1d are always shifted from each other.

The portions 1c and 1d are always shifted from each other to attract the magnet sheet MS, so that the sheet bundle SA can surely be concealed and wrapped. The N pole plane of the end portion 1c which is not magnetically attracted is used as the finger hook, so that the magnet sheet MS can easily be opened.

In the second embodiment, because the front surface 1a (see FIG. 10) of the magnet sheet MS constitutes the print surface, printing can be performed with a pencil, a ballpoint pen, a marker pen, and an inkjet printer. When an index is printed in the print surface, the sheet bundles (documents) SA concealed and wrapped by the magnet sheets MS can easily be sorted.

The front surface 1a of the magnet sheet MS may be magnetized or not magnetized. In the case where the front surface 1a is magnetized, the magnet sheet MS can be attached to a steel desk or shelf while the sheet bundle SA is wrapped.

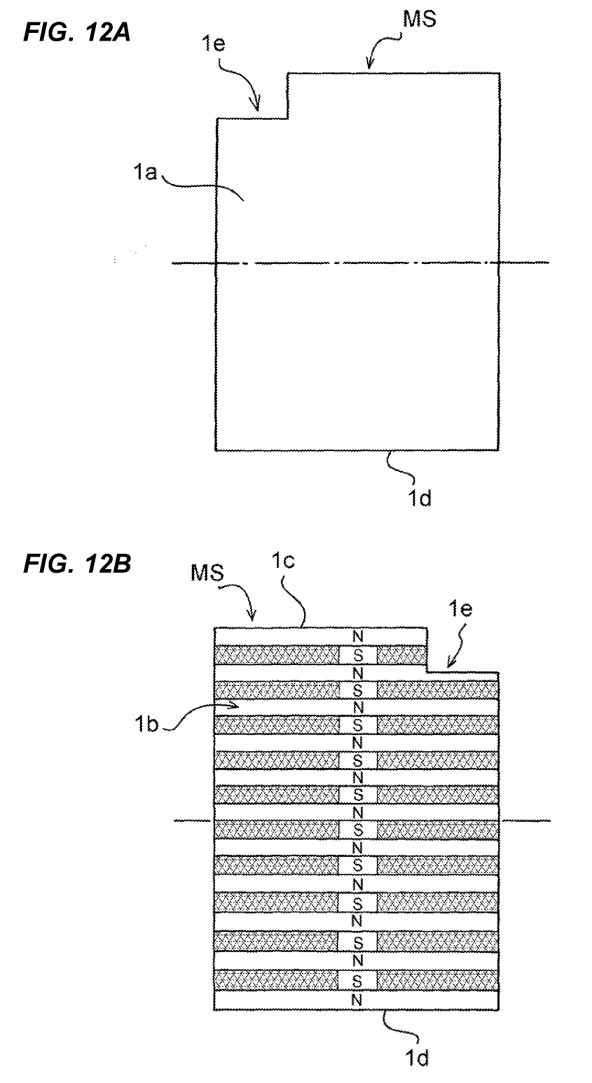

FIG. 12 is a view explaining a magnet sheet MS having another configuration, which is used in the sheet processing apparatus of the second embodiment. FIG. 12A illustrates the front surface 1a of the magnet sheet MS, and FIG. 12B illustrates the back surface 1b of the magnet sheet MS.

In the back surface 1b of the magnet sheet MS, the N poles and the S poles are alternately magnetized, and both the end portions 1c and 1d are magnetized in the N pole. A notch 1e is provided in the end portion 1c of the magnet sheet MS.

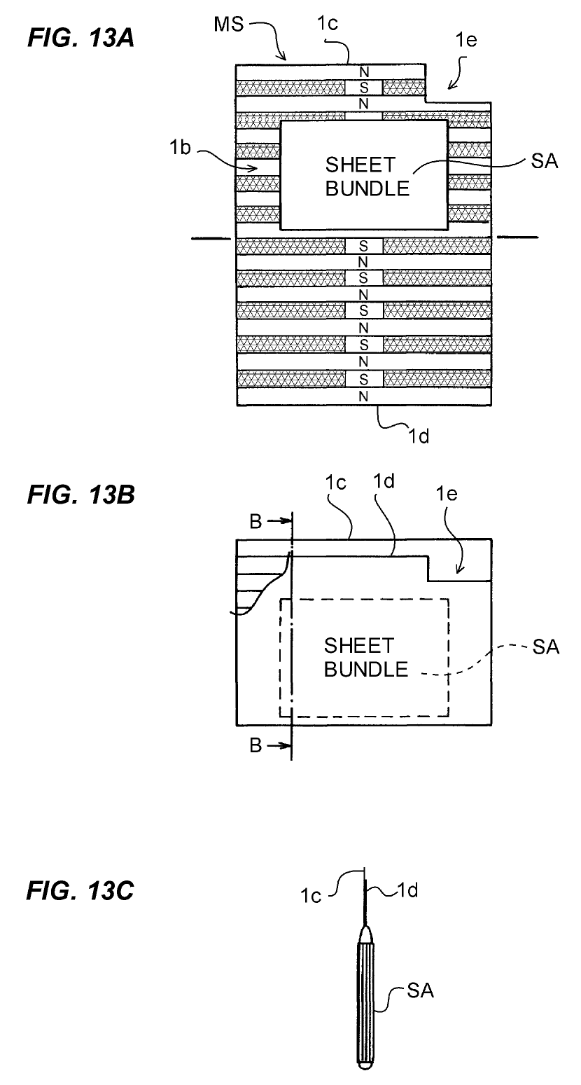

FIG. 13A illustrates a state in which the sheet bundle SA is placed on the back surface 1b of the magnet sheet MS. FIG. 13B illustrates a state in which the magnet sheet MS is folded into two such that the back surface 1b faces inward while the sheet bundle SA is wrapped, and FIG. 13C illustrates a section of the state in which the sheet bundle SA is wrapped.

When the magnet sheet MS is folded into two as shown in FIGS. 13B and 13C, the finger hook region can be enlarged to open the magnet sheet MS by providing the notch 1e. Therefore, the magnet sheet MS can more easily be opened. In the case where the two magnet sheets MS overlap each other, the magnet sheets MS can easily be opened by forming the notch 1e in one of the magnet sheets MS.

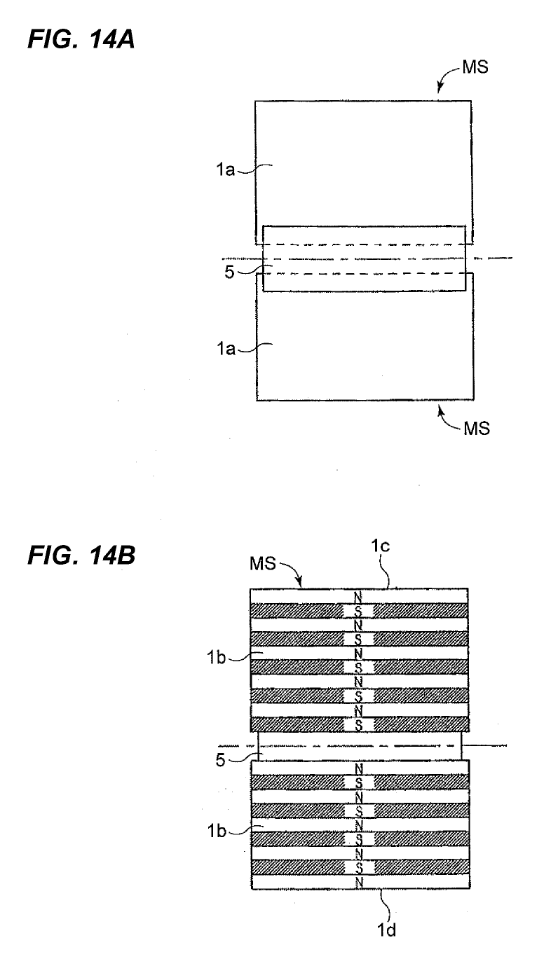

FIG. 14 is a view explaining a configuration of a wrapping tool in which the magnet sheet is used, the wrapping tool being used in the sheet processing apparatus of the second embodiment. FIG. 14A illustrates a printable surface of the wrapping tool, and FIG. 14B illustrates a backside. The wrapping tool is formed in such a manner that the two magnet sheets MS are joined with a flexible member 5 interposed therebetween.

In the back surface 1b of each magnet sheet MS, the N poles and the S poles are alternately magnetized, and the end portions 1c and 1d which are not joined to the flexible member 5 are magnetized in the N pole. Any flexible member such as a fiber sheet and a plastic sheet which plays a role of a hinge can be used as the flexible member 5, and the selection can be made in consideration of the necessary flexibility or durability.

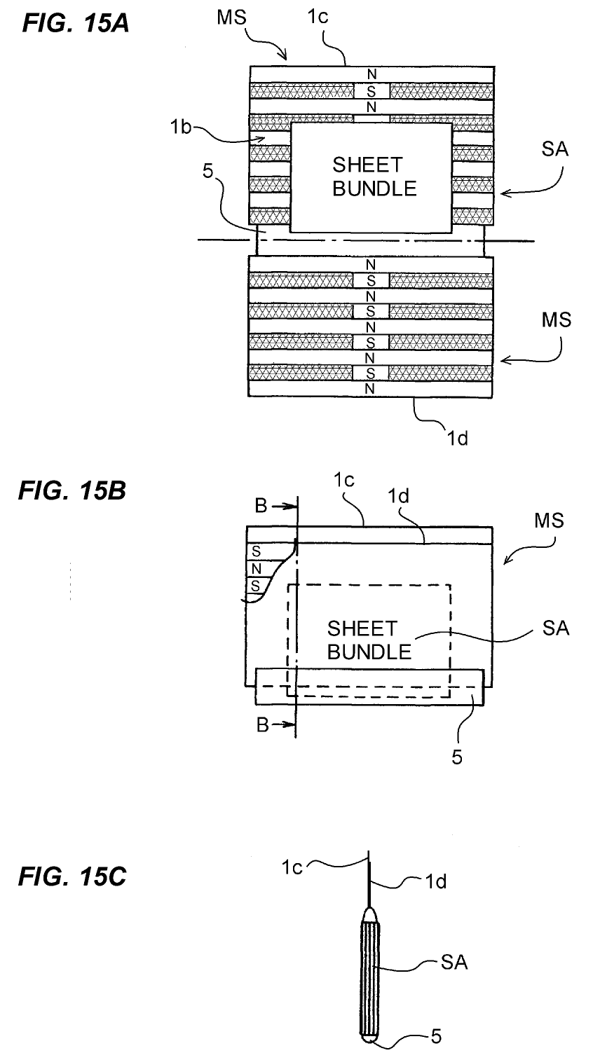

FIG. 15A illustrates a state in which the sheet bundle SA is placed on the backside of the wrapping tool, FIG. 15B illustrates a state in which the wrapping tool is folded into two while the sheet bundle SA is wrapped, and FIG. 15C illustrates a section of the state in which the sheet bundle is wrapped.

At this point, the sheet end portion 1c in the back surface 1b of one of the magnet sheets MS and the sheet end portion 1d in the back surface 1b of the other magnet sheet MS are magnetized in the N pole. Therefore, in the case where the wrapping tool is folded into two such that the backside faces inward, as shown in FIGS. 15B and 15C, the end portions 1c and 1d of the magnet sheets MS are magnetically repelled, the end portions 1c and 1d are not aligned with each other, and the portions 1c and 1d are always shifted from each other.

The portions 1c and 1d are shifted from each other to magnetically attract the N pole of the end portion 1d of one of the magnet sheets MS and the S pole of the end portion 1c of the other magnet sheet MS, so that the sheet bundle SA can surely be concealed and wrapped. The N pole plane of the end portion 1c which is not magnetically attracted is used as the finger hook, so that the magnet sheet MS can easily be opened.

In the second embodiment, the wrapping tool is formed by the two magnet sheets MS. Alternatively, the wrapping tool may be formed by at least three magnet sheets MS. In such cases, in a folded magnet sheet of at least the three magnet sheets, the two magnet sheets located at the opposite end to the folding portion of the folded magnet sheet are magnetized such that the end portions on the opposite side to the folding portion are magnetically repelled in the two magnet sheets.

In the second embodiment, because the front surface 1a of the magnet sheet MS constitutes the print surface, printing can be performed with a pencil, a ballpoint pen, a marker pen, and an inkjet printer. When an index is printed in the print surface, the sheet bundles (documents) concealed and wrapped by the magnet sheets MS can easily be sorted.

The front surface 1a of the magnet sheet MS may be magnetized or not magnetized. In the case where the front surface 1a is magnetized, the magnet sheet MS can be attached to a steel desk or shelf while the sheet bundle is wrapped.

Thus, in the second embodiment, the end portions located on the opposite side to the folding portion of the magnet sheet are always shifted from each other in wrapping the sheet bundle. Therefore, in opening the magnet sheet, the finger can easily be put on the end portion, and the operability is improved. The magnetic force can be strengthened because of the magnet sheet is easily opened, and the sheet bundle can surely be concealed and wrapped.

In the first and second embodiments, the sheet bundle is wrapped by the magnet sheet. Alternatively, after the image is directly formed in the magnet sheet, the magnet sheet can be folded into two.

A third embodiment of the invention, in which the magnet sheet is folded into two after the image is directly formed in the magnet sheet, will be described below.

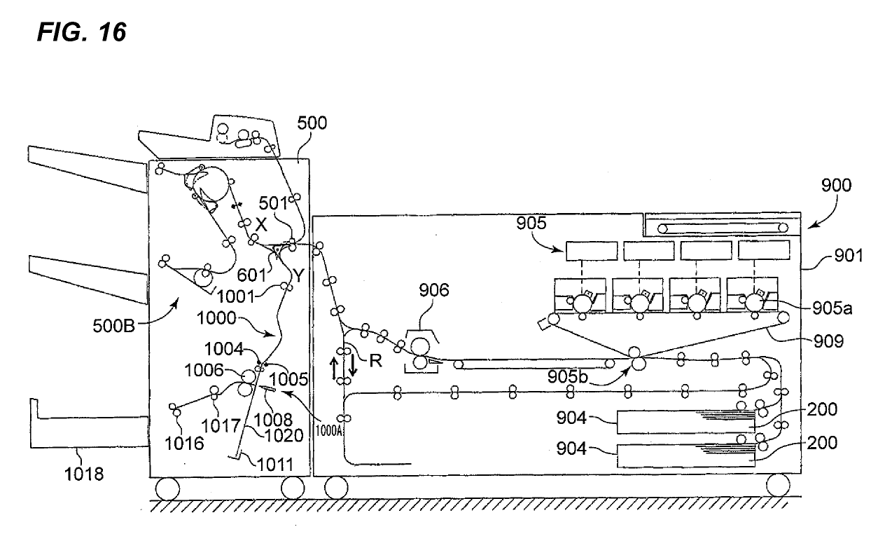

FIG. 16 illustrates a configuration of an image forming apparatus of the third embodiment. In FIG. 16, the identical or equivalent component is designated by the same numeral as that of FIG. 1.

In the third embodiment, the image forming portion 905 primary-transfers yellow, magenta, cyan, and black toner images formed on photosensitive drums 905a to an intermediate transfer belt 909, and a secondary transfer portion 905b transfers the yellow, magenta, cyan, and black toner images primary-transferred to the intermediate transfer belt 909 to the sheet.

In FIG. 16, a magnet sheet 200 is formed by a permanent magnet, and the magnet sheet 200 is accommodated in the sheet feed cassette 904. The magnet sheet 200 is made of ferrite which is of a magnetic material.

The sheet feed cassette 904 accommodates the magnet sheet 200 and normal sheets (not shown) therein, and the sheet feed cassette 904 can be drawn in a front direction of FIG. 16. The supply of the magnet sheet 200 and jam recovery can be performed by drawing the sheet feed cassette 904 to the front side.

Desirably the sheet feed cassette 904 and the sheet conveying path are made of plastic or non-magnetic metal such that the magnet sheet 200 is not attracted to the sheet feed cassette 904 and the sheet conveying path by the magnetic force of the magnet sheet 200.

In forming the image in the magnet sheet 200, the magnet sheet 200 is delivered from the sheet feed cassette 904 and conveyed to the secondary transfer portion 905b. In the secondary transfer portion 905b, the toner image on the intermediate transfer belt is transferred, thereby obtaining the color image in which the yellow, magenta, cyan, and black toner images are superposed on the magnet sheet.

Then, the magnet sheet 200 in which the four-color toner image is transferred is conveyed to the fixing portion 906 to permanently fix the toner image. At this point, because the magnet sheet 200 has a heat capacity larger than that of the normal sheet, a sheet conveying speed in the fixing portion 906 may be set slower than that of the normal sheet such that the sufficient heat is applied to the magnet sheet 200.

For the color of the image, in the case where the magnet sheet 200 has a color of the ferrite which is of the magnetic material, because the magnet sheet 200 becomes dark purple, the normal full-color image or the monochrome black image is hardly seen when the image is directly formed.

Therefore, in forming the image in the magnet sheet 200, the color of the formed image may be adjusted according to the color of the magnet sheet 200. For example, an operator specifies the use of the magnet sheet on the manipulation panel, the control apparatus determines that the image forming surface has a dark purple background, the image is formed in light colors compared with the image formation on the normal white sheet, or the image is printed while converted into a bright color such as yellow in the case of the monochrome black image. When the image is formed in white which is of a special color, the image is easily visible on the magnet.

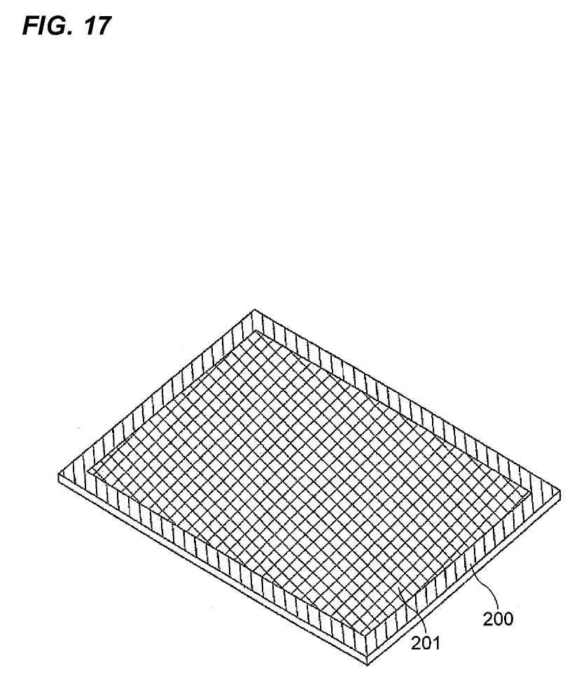

For example, as shown in FIG. 17, the image can be formed like normal recording paper by providing an image recording layer 201 in a first plane of the magnet sheet 200. The image recording layer 201 is a white or pale image forming layer in which the image can be formed for the purpose of information recording. The image recording layer 201 is formed by bonding thin paper onto the magnet sheet or coloring the front surface of the magnet sheet with white paint.

After the toner image is fixed, the magnet sheet 200 is conveyed to the finisher 500. In the third embodiment, the finisher 500 sequentially takes in the sheet discharged from the image forming apparatus main body 901, and the finisher 500 aligns the taken-in plural sheets to bundle the sheets. The finisher 500 also performs various processes such as a staple process for binding the back end of the sheet bundle with a staple, a sort process, a non-sort process, the saddle stitching process, and the folding process.

The finisher 500 includes a folding bookbinding processing portion 1000 and a side stitching bookbinding portion 500B. The folding bookbinding processing portion 1000 performs folding bookbinding to the sheets and magnet sheet 200. The side stitching bookbinding portion 500B performs side stitching to the sheets. A switching member 601 is provided in a downstream of the pair of entrance rollers 501 of the finisher 500. The switching member 601 guides the sheet to a path X or a path Y, the sheet is conveyed through the path X to the side stitching bookbinding portion 500B which performs the side stitching, and the sheets and magnet sheet 200 are conveyed through the path Y to the folding bookbinding processing portion 1000 which performs the folding bookbinding.

The folding bookbinding processing portion 1000 includes a storage guide 1020 and a movable sheet positioning member 1011. The magnet sheet 200 is accommodated in the storage guide 1020. The movable sheet positioning member 1011 is provided below the storage guide 1020, and the movable sheet positioning member 1011 positions the magnet sheet accommodated in the storage guide 1020.

The two pairs of staplers 1005 are provided in the storage guide 1020, and the staplers 1005 perform the saddle stitching to the sheet bundle in cooperation with an anvil 1004 facing the staplers 1005. A folding member 1000A is provided in the downstream of the stapler 1005, and the folding member 1000A includes a pair of folding rollers 1006 and an ejecting member 1008 which is provided while facing the pair of folding rollers 1006.

The operation for folding the magnet sheet 200, performed by the folding bookbinding processing portion 1000 having the above-described configuration, will be described below.

When the magnet sheet 200 is guided to the folding bookbinding path Y by the switching member 601, while the magnet sheet 200 is accommodated in the storage guide 1020, the magnet sheet 200 is conveyed by the pair of conveying rollers 1001 until the forefront of the sheet contacts the movable sheet positioning member 1011. At this point, when the magnet sheets 200 overlap each other, the magnet sheets 200 bonded to each other by the magnetic forces, which possibly causes misalignment and conveyance failure. Therefore, the magnet sheet 200 is always processed one by one in conveying the magnet sheet 200.

Then, the ejecting member 1008 is moved in the direction of the pair of folding rollers 1006 with respect to the magnet sheet 200 which contacts the sheet positioning member 1011, thereby pushing the magnet sheet 200 into the nip portion of the pair of folding rollers 1006. At this point, the forefront position of the magnet sheet 200 is regulated by the sheet positioning member 1011 such that the ejecting member 1008 pushes the center portion in the conveying direction of the magnet sheet 200.

The magnet sheet 200 is pushed into the nip portion of the pair of folding rollers 1006, whereby the magnet sheet 200 is folded into two such that the first plane in which the image recording layer 201 is formed faces inward. The magnet sheet 200 folded into two by the pair of folding rollers 1006 is conveyed by the conveying roller 1017, and the magnet sheet 200 is discharged onto the tray 1018 by the discharge roller 1016 constituting the sheet discharge portion.

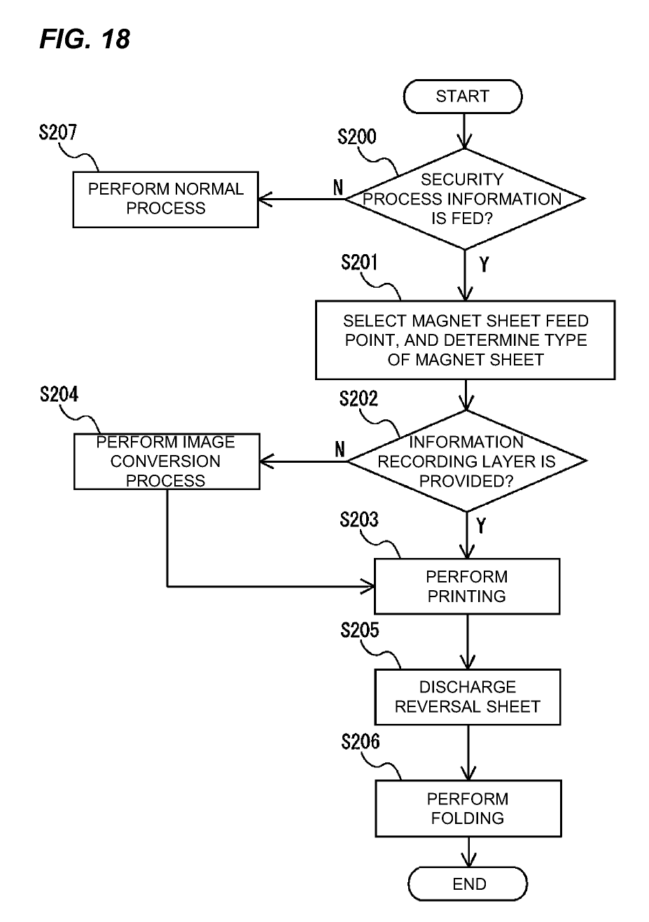

Control in a security process which is of an image masking process performed by the image forming apparatus 900 including the above-described finisher 500 will be described with reference to a flowchart of FIG. 18.

The user sets security process information with the external computer 211 or manipulation portion 209 of FIG. 8, and the security process information is fed into the CPU circuit portion 206 through the external I/F 201.

When the security process information is fed (Y in S200), sheet feed point of the magnet sheet used is selected, and a determination whether the magnet sheet is a type having the image recording layer (white background) or a dark purple type having no image recording layer is made according to the magnet sheet type information fed along with the security process information (S201). For example, a multi sheet tray or a previously-set cassette can be selected as the sheet feed point. The magnet sheet type is fed from the external computer 211 or manipulation portion 209.

In the case where the magnet sheet is the type having the image recording layer (Y in S202), the CPU circuit portion 206 controls the printer control unit 205 to print the same image as the normal white sheet on the magnet sheet according to the color of the image recording layer (S203).

In the case where the magnet sheet is the type having no image recording layer (N in S202), CPU circuit portion 206 controls the printer control unit 205 to perform an image conversion process (S204). Specifically, the original image is converted into monochrome yellow image such that printing contents are easily recognized even in the color of the dark background such as ferrite when the original image is formed in monochrome black color, the original image is converted into an easily-viewable bright-tone image using a color conversion table when the original image is the color image. After the image conversion process is performed, the image is printed on the magnet sheet (S203).

The toner image printed on the magnet sheet is fixed, and the magnet sheet 200 is caused to enter a reversal path R shown in FIG. 16 to reverse the magnet sheet, and the magnet sheet is reversely discharged toward the finisher 500 (S205).

The reason why the magnet sheet 200 is reversed is that confidential contents face inward when the magnet sheet 200 is folded into two by the finisher 500. The same holds true except that a reversing mechanism is provided on the finisher side or the folding member can be folded inward and outward.

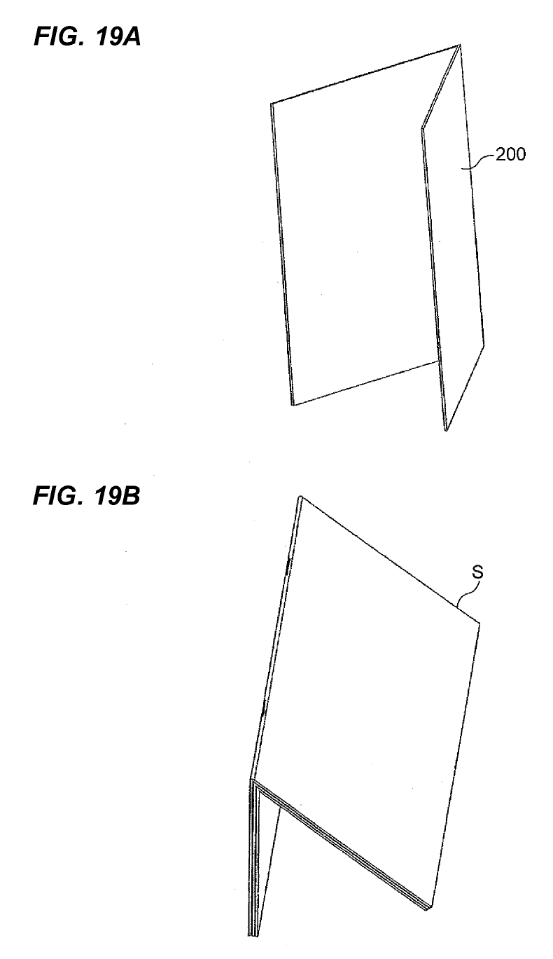

Then, the folding member 1000A of the folding bookbinding processing portion 1000 folds the magnet sheet delivered to the finisher 500 (S206). Therefore, as shown in FIG. 19A, magnet sheet 200 is folded such that the confidential contents face inward, and the sheet discharge roller 1016 discharges the sheets wrapped by the magnet sheet to the outside of the finisher 500 while the contact surfaces of the magnet sheet are closed by the magnetic force.

In the case where the security process is eliminated, that is, in the case where the security process information is not fed (N in 200), the normal process is performed (S207). Then, in the case where the bookbinding process is performed, the folding bookbinding processing portion 1000 performs the binding and performs the folding (S206). Therefore, as shown in FIG. 19B, the normal sheet is discharged to the outside of the finisher 500 while the center of the sheet is folded.

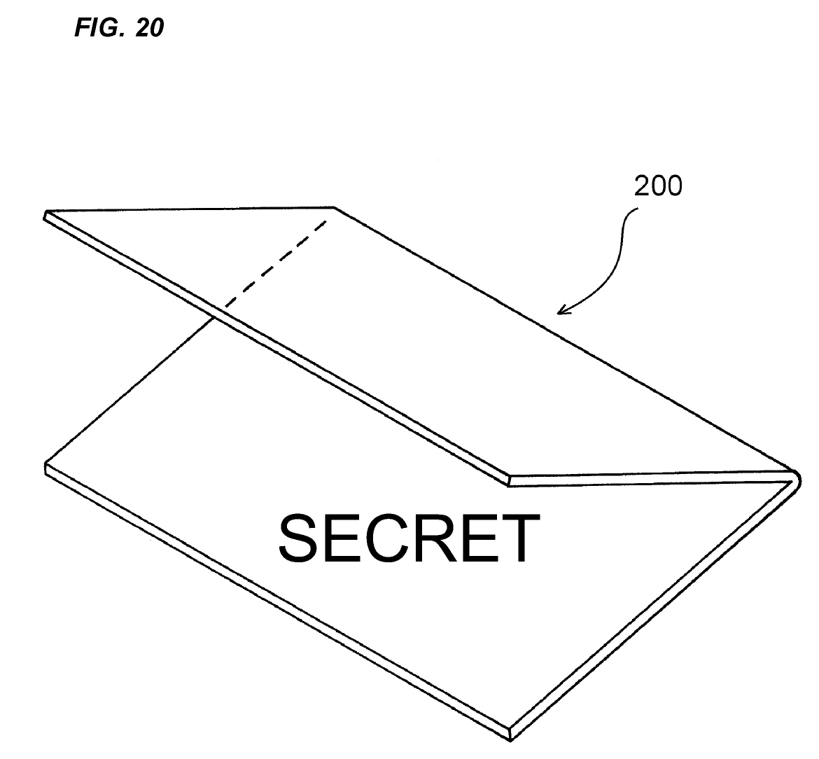

As shown in FIG. 19A, contents of the closely-contacted magnet sheet 200 whose confidential contents are folded inward can be seen by opening the magnet sheet 200 as shown in FIG. 20.

Thus, in the third embodiment, after the image is formed in the magnet sheet 200, the magnet sheet 200 is folded. Therefore, the need of the dedicated binding process apparatus is eliminated and the security can be ensured without enlarging the apparatus. Because the permanent magnet is utilized, the magnet sheet can be maintained in the closed state when the magnet sheet 200 is folded into two even after the contents are confirmed.

In the first to third embodiments, the force for wrapping around the sheet bundle or the force for closely contacting the magnet sheets is kept constant according to the magnetic force of the magnet sheet. Alternatively, the force for wrapping around the sheet bundle can be varied.

A fourth embodiment of the invention, in which the force for wrapping around the sheet bundle is variable, will be described below.

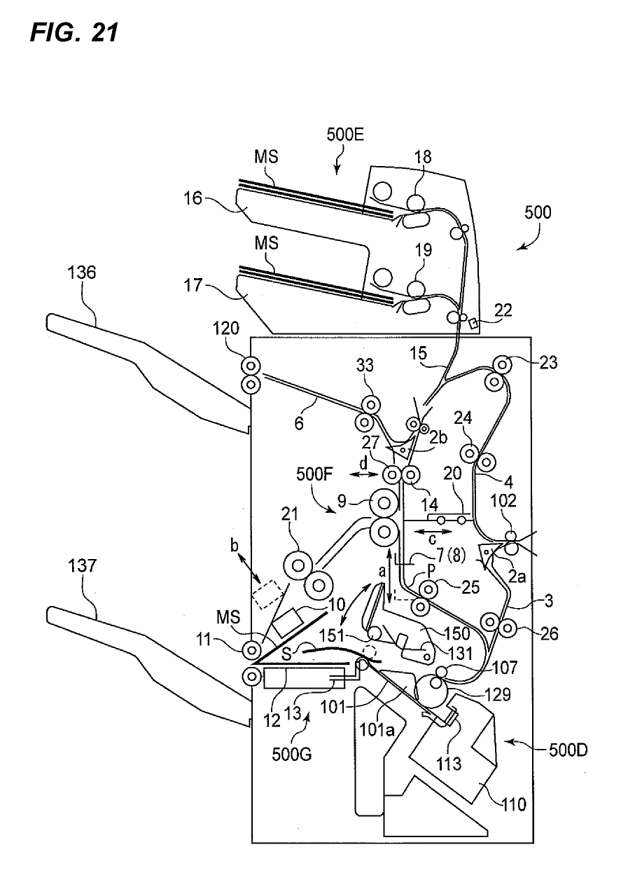

FIG. 21 illustrates a configuration of a sheet processing apparatus of the fourth embodiment.

In the fourth embodiment, the finisher 500 sequentially takes in the sheet discharged from the image forming apparatus main body 901, and the finisher 500 aligns the taken-in plural sheets to bundle the sheets. The finisher 500 also performs various processes such as the staple process for binding the back end of the sheet bundle with the staple, the sort process, the non-sort process, the saddle stitching process, and the folding process.

The finisher 500 includes a staple processing portion 500D, an inserting portion 500E, a folding member 500F, and an insertion portion 500G. The staple processing portion 500D staples the sheets. The inserting portion 500E inserts the magnet sheet MS which wraps the stapled sheet bundle and the sorted sheet. The folding member 500F folds the magnet sheet MS conveyed from the inserting portion 500E. The insertion portion 500G inserts the sheet into the folded magnet sheet MS.

The staple processing portion 500D includes a processing tray 101, a return member such as a paddle 131 and a roulette belt 129, a back end stopper 113 and an aligning plate 101a. The aligning plate 101a can be moved in a width direction orthogonal to the conveying direction, and the aligning plate 101a aligns the width direction of the sheet. The staple processing portion 500D includes a stapler 110 which staples the sheet bundle if needed after the sheet bundle is aligned by the aligning plate 101a.

The inserting portion 500E includes insert trays 16 and 17 in which the inserted magnet sheets MS are accommodated and sheet feed rollers 18 and 19 which supply the magnet sheets MS stacked on the insert trays 16 and 17.

The folding member 500F includes a pair of drawing rollers 14 and 27 which can be brought close to and separated from each other as shown by an arrow d, forefront stoppers 7 and 8 which align the conveying direction of the sheet, and a folding roller 9, and a striking plate 20.

As shown by an arrow a, using a driving source (not shown) and a home position sensor (not shown), the forefront stoppers 7 and 8 can separately be moved between an alignment position shown by a solid line and a position which is shown by a broken line and retracted from a conveying path P. As described later, the forefront stoppers 7 and 8 constitute an inclining member which inclines the magnet sheet, and the forefront stoppers 7 and 8 can be set at different heights.

The insertion portion 500G includes a second processing tray 12 and a suction member 10. The sheet bundle stapled by the staple processing portion 500D and the sorted sheets are stacked on the second processing tray 12. The suction member 10 can be moved in a direction of an arrow b.

The suction member 10 is formed by a suction air member. The suction air member has a suction force stronger than the magnetic attraction force (magnetic force) of the magnet sheet MS, and the suction air member can be turned on and off. The suction member 10 can open the magnet sheet stacked on the second processing tray 12. The insertion portion 500G also includes a pair of sheet-bundle discharge rollers 151. The pair of sheet-bundle discharge rollers 151 constitutes the conveying portion which conveys the sheet bundle to the opened magnet sheet.

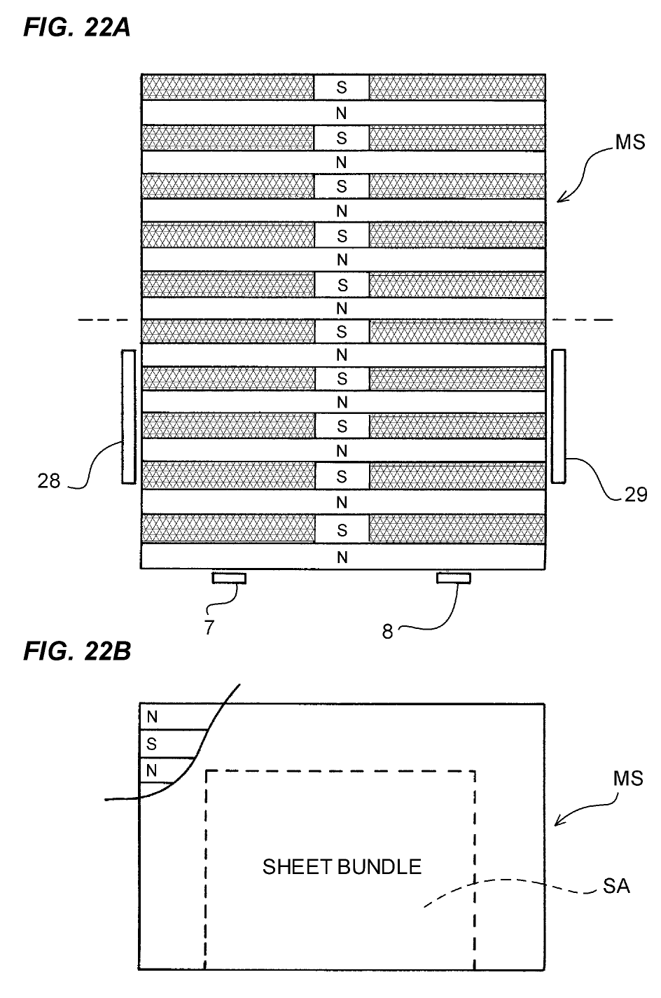

In the fourth embodiment, as shown in FIG. 22A, the inserted magnet sheet MS is formed by a belt-shape magnetic plate in which the S poles and the N poles are alternately disposed. In the case where the magnet sheet is folded in the folding portion shown by a dotted line, or in the case where two magnet sheets overlap each other, the S pole and the N pole attract each other to generate the attraction force (magnetic force), thereby supporting the sheet or sheet bundle.

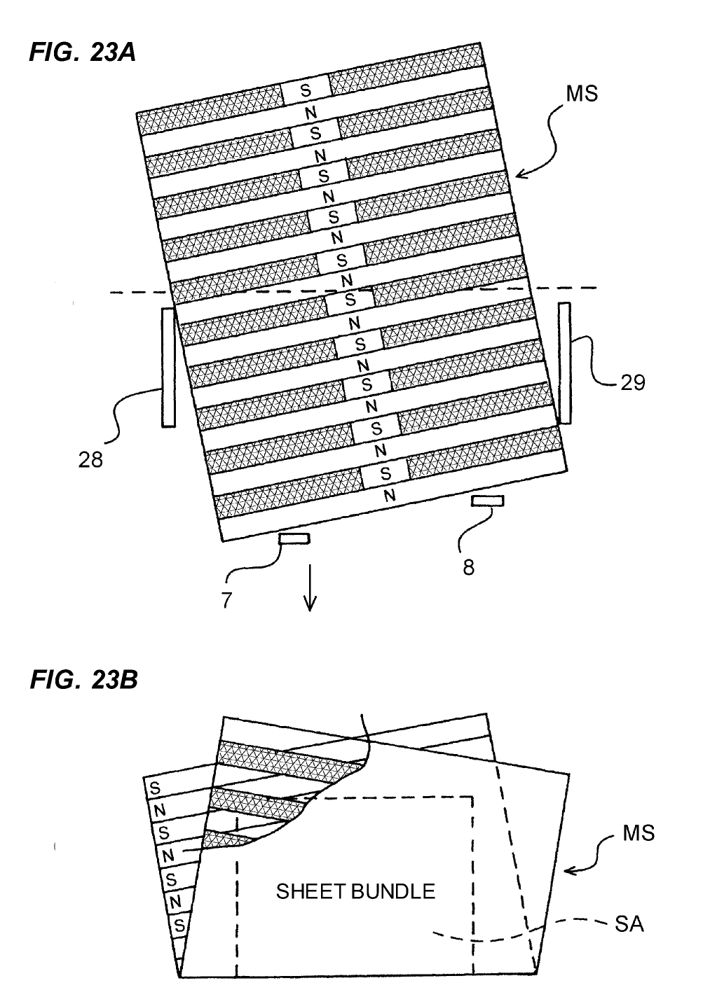

In the case where the folding member 500F folds the magnet sheet MS, the strong attraction force (magnetic force) is generated when the S pole and the N pole attract each other while facing each other in parallel. On the other hand, when the magnet sheet MS is folded while obliquely conveyed as shown in FIG. 23A, the magnet sheet MS obliquely overlaps as shown in FIG. 23B.

In the case shown in FIG. 23B, the attraction force (magnetic force) is generated weaker than the case in which the S pole and the N pole attract each other while facing each other in parallel as shown in FIG. 22B. That is, in the case where the magnet sheet MS is folded, the case in which the magnet sheet MS overlaps straightly differs from the case in which the magnet sheet MS overlaps obliquely in magnitude of the attraction force (magnetic force).

Therefore, in the fourth embodiment, when the magnet sheet MS is folded, the magnitude of the attraction force (magnetic force) is changed by straightly or obliquely overlapping the magnet sheet MS.

In FIGS. 22 and 23, aligning plates 28 and 29 align the width direction of the magnet sheet MS, and the aligning plates 28 and 29 are provided so as to be able to be independently moved. The alignment positions of the aligning plates 28 and 29 are changed according to the case in which the magnet sheet MS overlaps straightly and the case in which the magnet sheet MS overlaps obliquely.

The operation of the sheet processing apparatus 500 will be described below.

When the sheet is discharged from the image forming apparatus main body 901, the sheet is delivered to the pair of entrance rollers 102 of the finisher 500 shown in FIG. 21. Then, the pair of entrance rollers 102 delivers the sheet to a conveying path 4 or a conveying path 3 through switching member 2a which is switched according to a mode. In the case of the modes such as a non-sort mode, the sheet passes through the conveying path 4, the sheet is conveyed to the sheet discharge port 120 by the switching member 2b, and the sheet is discharged to the upper tray 136. At this point, an entrance sensor (not shown) detects sheet delivery and receipt timing.

In the case of the modes in which the staple process and sort process are performed, the sheet passes through the conveying path 3 by switching the switching member 2a, and the sheet is discharged onto the processing tray 101 by the sheet discharge roller 107. On the processing tray, the conveying direction of the sheet is aligned by the return member such as the paddle 131 and the roulette belt 129, and the back end stopper 113. Then, the width direction of the sheet is aligned by the aligning plate 101a, and the predetermined number of sheets is aligned to form the sheet bundle on the processing tray 101. Then, the stapler 110 performs the binding process if needed.

The sheet bundle is discharged to the second processing tray 12 by the pair of sheet-bundle discharge rollers 151. The pair of sheet-bundle discharge rollers 151 is rotatably supported by a swing guide 150 which can be swung, and the pair of sheet-bundle discharge rollers 151 can be brought close to and separated to each other. Then, the sheet is discharged to the lower tray 137 by the sheet bundle pushing member 13 and a pair of second bundle conveying rollers 11 which constitute the sheet discharge portion.

On the other hand, when the security process mode is selected, the magnet sheets MS stacked on the insert trays 16 and 17 are delivered by the sheet feed rollers 18 and 19. In the case where the folding process is performed to the magnet sheet MS, the delivered magnet sheet MS abuts on the forefront stoppers 7 and 8 to achieve the alignment.

As shown in FIG. 22, the width direction of the magnet sheet MS is aligned by the aligning plates 28 and 29 which can independently be moved. Then, the magnet sheet MS is pushed into the nip portion of the pair of folding rollers 9 by the striking plate 20, and the magnet sheet MS is conveyed while folded into two by the pair of folding rollers 9. The half-folded magnet sheet MS is conveyed to the second processing tray 12 by the conveying roller 21.

In the case where the folding process is not performed, the forefront stoppers 7 and 8 are previously retracted from the conveying path P to the position shown by the broken line. Therefore, the delivered magnet sheet MS is conveyed to the conveying roller 25, and the magnet sheet MS is discharged onto the processing tray 101 by the conveying roller 25.

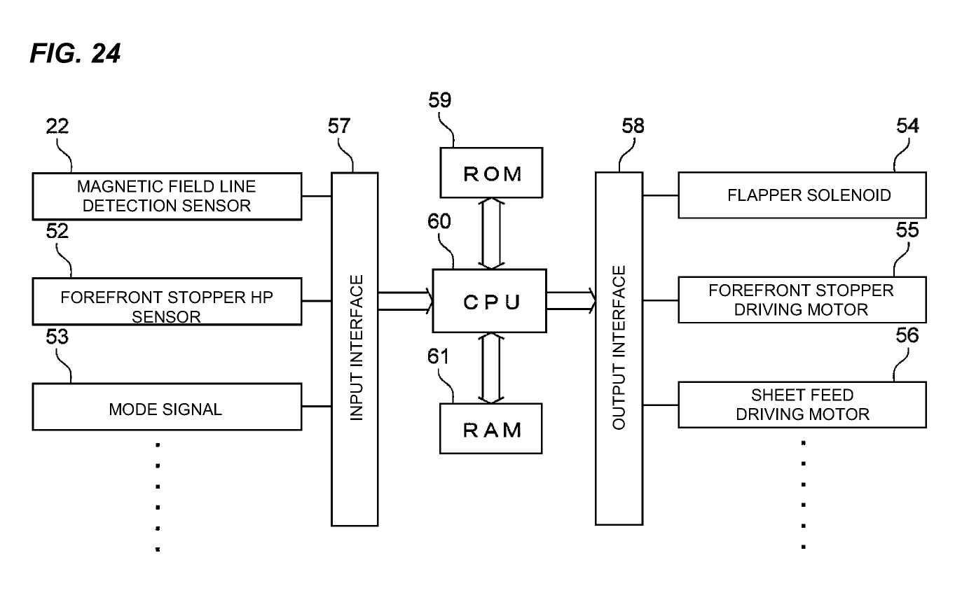

FIG. 24 is a control block diagram illustrating the sheet processing apparatus (finisher) 500 of the fourth embodiment. In FIG. 24, a sheet folding processing program and a staple processing program are previously stored in ROM 59. CPU 60 executes each program, and CPU 60 performs input data process while appropriately conducting data communication with RAM 61, thereby producing a predetermined control signal.

In FIG. 24, a forefront stopper HP sensor 52 detects Home Positions (HP) of the forefront stoppers 7 and 8, and a magnetic field line detection sensor 22 detects the magnetic field line of the magnet sheet MS shown in FIG. 21. Signals from the magnetic field line detection sensor 22 and the forefront stopper HP sensor 52 and a mode signal from the manipulation portion are fed into CPU 60 through an input interface 57.

When the signal is fed into CPU 60, CPU 60 transmits each control signal to a forefront stopper driving motor 55 through an output interface 58 and a driver (not shown). The forefront stopper driving motor 55 vertically moves a flapper solenoid 54 and the forefront stoppers 7 and 8. CPU 60 also transmits each control signal to a sheet feed driving motor 56 of the inserting portion 500E, driving motors of the aligning members 28 and 29 of the folding member 500F.

In the fourth embodiment, the data communication is conducted between the main body-side CPU circuit portion 206 (see FIG. 8) and CPU 60. Therefore, CPU 60 takes in various pieces of information such as the copy mode, the original size, and the number of original copies by the automatic original conveying apparatus.

In the fourth embodiment, when the security process mode is selected, as described above, after the magnet sheet MS is folded into two the sheet S in which the image is formed is wrapped by the folded magnet sheet MS.

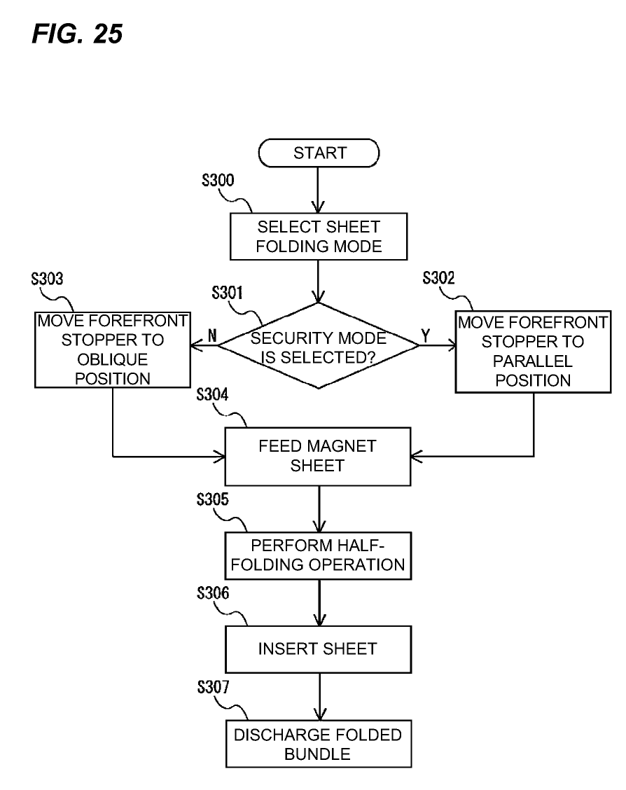

The operation for wrapping around the sheet S, in which the image is formed, by the half-folded magnet sheet MS will be described below with reference to a flowchart of FIG. 25.

When the user selects the sheet folding mode which is of the security process mode (S300), CPU 60 selects one of the security mode and the temporarily binding mode which are set in the sheet folding mode (S301). When the security mode is selected (Y in S301), the forefront stoppers 7 and 8 are lowered from the home positions and moved to the positions parallel to each other (parallel position) as shown in FIG. 22A (S302).

When the temporarily binding mode is selected (N in S301), the forefront stoppers 7 and 8 are moved to oblique positions which have predetermined positions with respect to a folding line shown by the broken line as shown in FIG. 23A (S303). Specifically, the forefront stopper 7 is moved more downward than the forefront stopper 8. The inclination of the magnet sheet MS depends on a difference in height between the forefront stoppers 7 and 8.

The selected mode is not limited to the security mode and the temporarily binding mode. For example, a level of the attraction forces (magnetic force) such as strong and weak may be selected. The stop position of the forefront stopper 7 is not limited to one point, but the inclination can be changed by changing the stop position of the forefront stopper 7.

Then, the magnet sheets MS stacked on the insert trays 16 and 17 are fed (S304). The magnet sheet MS abuts on the forefront stoppers 7 and 8 through the switching member 2b provided in the conveying path 15. At this point, the drawing rollers 27 may be separated to cause the magnet sheet MS to abut on the forefront stoppers 7 and 8 by the weight of itself.

The aligning plates 28 and 29 align the width direction of the magnet sheet MS. At this point, as shown in FIG. 23A, because the magnet sheet MS is obliquely aligned by the forefront stoppers 7 and 8 having the different heights, the alignment is widely performed in consideration of the skew of the sheet compared with the alignment of the magnet sheet MS in the straight state shown in FIG. 22A.

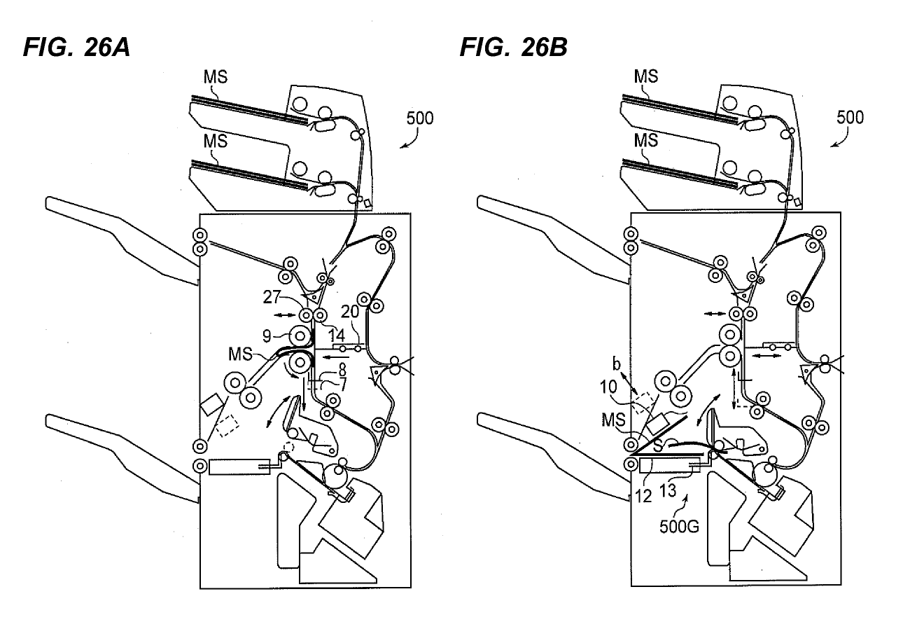

When the alignment of the magnet sheet MS is ended, as shown in FIG. 26A, the striking plate 20 pushes the substantial center of the magnet sheet MS into the nip of the folding roller 9. Therefore the folding roller 9 performs the folding process (half-folding operation) to the magnet sheet MS (S305). At this point, the folding process is performed to the magnet sheet MS according to the usage as shown in FIGS. 22B and 23B by the state in which the magnet sheet MS is supported by the forefront stoppers 7 and 8.

As shown in FIG. 26B, the magnet sheet MS to which the folding process is performed is discharged from the conveying roller 21 onto the second processing tray 12. The lower surface of the half-folded magnet sheet MS is sucked to the second processing tray 12 by a suction member (not shown), and the upper surface of the half-folded magnet sheet MS is sucked and opened by the suction member 10 which can be moved in the direction of the arrow b.

Thus, after the magnet sheet MS is discharged on the second processing tray 12, the opposite end to the folding portion in the magnet sheet MS is opened by the suction member 10 constituting the opening and closing portion which opens and closes the magnet sheet MS. On the second processing tray 12, the conveying direction and width direction are aligned by the aligning member (not shown) before the magnet sheet MS is sucked, and the opening operation is performed. Therefore, an appearance of the product becomes better.

The insertion portion 500G inserts the sheet S into the opened magnet sheet MS (S306). Particularly, as described above, the sheet S or sheet bundle in which the image is formed is aligned on the processing tray 101, the staple process or non-binding process is performed, and the sheet-bundle discharge roller 131 discharges the sheet S or sheet bundle into the magnet sheet MS. Therefore, the sheet bundle SA (or sheet) is covered with the magnet sheet MS as shown in FIGS. 22B and 23B.

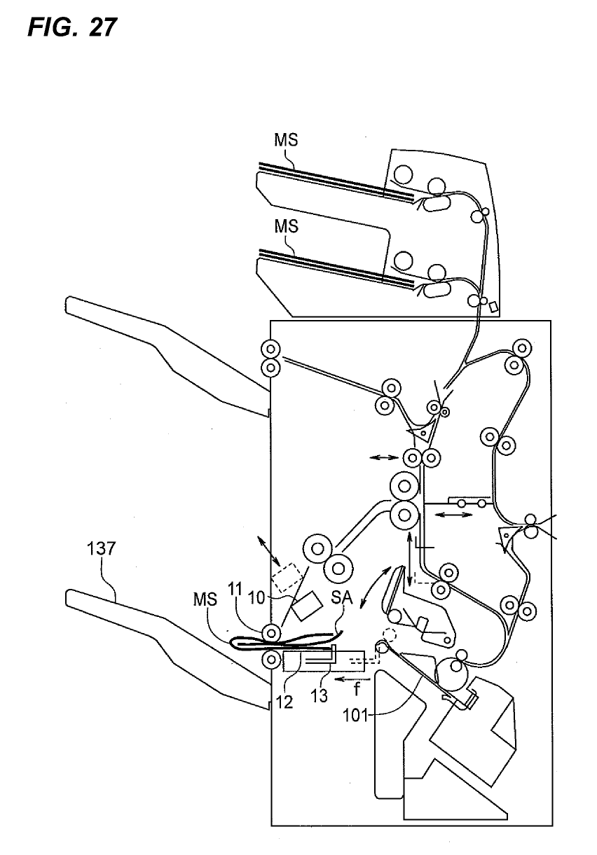

Then, as shown in FIG. 27, the suction force of the suction member 10 is released to close the magnet sheet MS, thereby wrapping around the sheet bundle by the magnet sheet MS. Then, the pushing member 13 is moved in a direction of an arrow f, and the second bundle conveying roller 11 discharges the sheet bundle onto the stack tray 201 while the sheet bundle wrapped by the magnet sheet MS. That is, the sheet bundle wrapped by the half-folded magnet sheet MS is discharged (S307). At this point, the sheet S and the sheet bundle are supported by the attraction force (magnetic force) of the magnetic surfaces of the half-folded magnet sheet.

At this point, as shown in FIG. 22B, when the magnet sheet MS is folded such that the N pole and the S pole attract while facing each other in parallel, the strong attraction force is exerted, so that the sheet bundle can surely be wrapped. Additionally, when the magnet sheet MS is folded such that the N pole and the S pole obliquely attract each other, the sheet bundle can be wrapped with the weak attraction force as shown in FIG. 23B.

Thus, in the fourth embodiment, not only the product having the strong attraction force but the product having the weak attraction force generated by inclining the magnet sheet MS can be produced according to the usage. In the case where the magnet sheet MS is folded, the magnet sheet MS may be folded by bending the magnet sheet MS with no use of the striking plate 20, or the insertion portion 500G may have a different configuration.

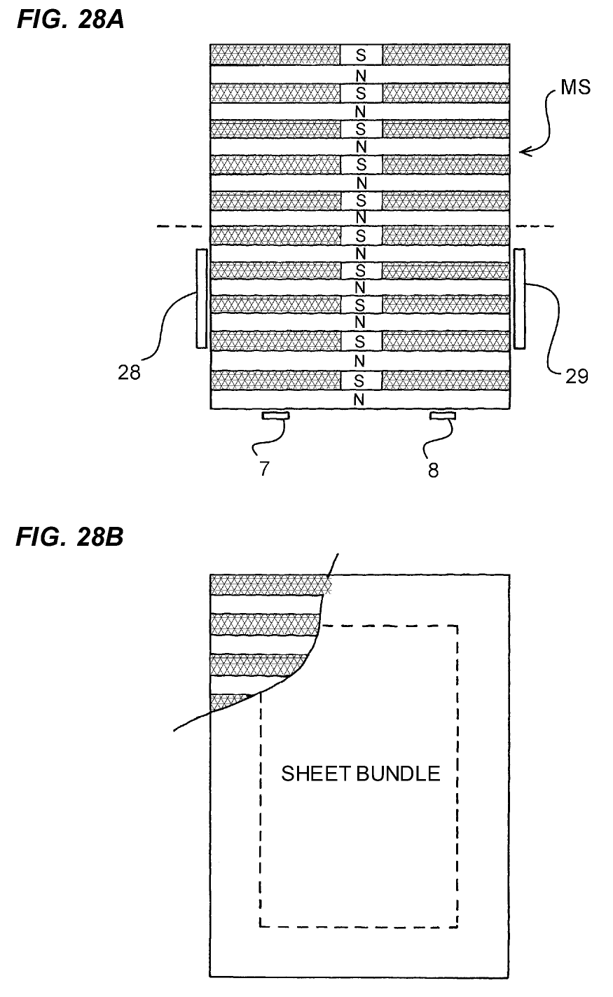

In the above description, the sheet bundle is wrapped by the one magnet sheet. As shown in FIG. 28, the sheet bundle may be wrapped by the two magnet sheets. In such cases, the sheet bundle is wrapped while the two magnet sheets MS are parallelized as shown in FIG. 28A, or the sheet bundle is wrapped while the two magnet sheets MS overlap with a given angle as shown in FIG. 28B.

In the fourth embodiment, the magnet sheets MS are stacked and accommodated in the insert trays 16 and 17 as shown in FIG. 21. When the sheet bundle is wrapped around by the two magnet sheets MS, the two magnet sheets MS are selectively or sequentially delivered from the insert trays 16 and 17.

When the sheet bundle is wrapped around by the two magnet sheets MS, the user selects a magnet sheet overlapping mode which is of a mode for wrapping the sheet bundle SA by the two magnet sheets MS. When the magnet sheet overlapping mode is selected, CPU 60 (see FIG. 24) selects one of the security mode and the temporarily binding mode on the basis of the next fed mode signal 53 (see FIG. 24).

The security mode is a mode in which the two magnet sheets MS attracts each other with the strong attraction force, and the temporarily binding mode is a mode in which the two magnet sheets MS attracts each other with the relatively weak attraction force.

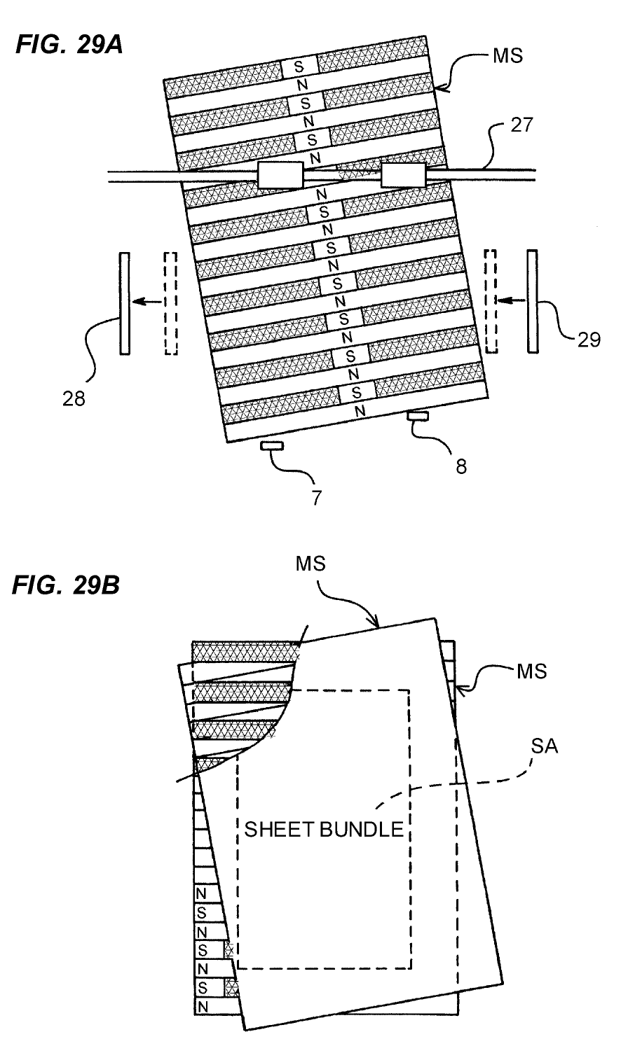

When the security mode is selected, the forefront stopper driving motor 55 is driven to move the forefront stoppers 7 and 8 to the positions at which the forefront stoppers 7 and 8 are parallelized as shown in FIG. 28A. When the temporarily binding mode is selected, the forefront stoppers 7 and 8 are moved so as to become the positional relationship in which the forefront stoppers 7 and 8 have the different heights as shown in FIG. 29A.

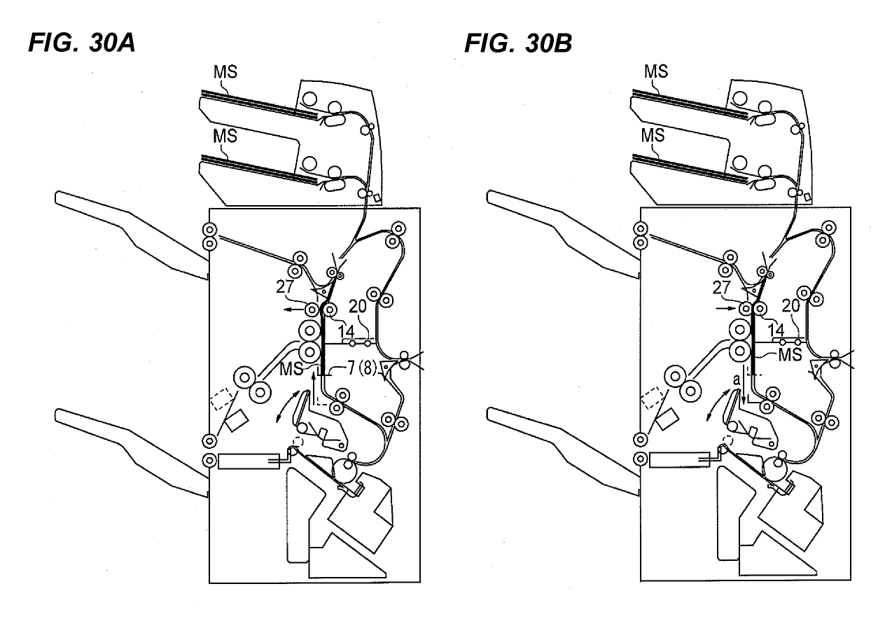

Then, as shown in FIG. 30A, the magnet sheets MS stacked on the insert trays 16 and 17 are fed, and the magnet sheets MS abut on the forefront stoppers 7 and 8 through the conveying path 15 and the switching member 2b. At this point, the drawing rollers 27 are separated in the arrow direction, the magnet sheets MS abut on the forefront stoppers 7 and 8 by the weight of themselves to align the forefronts of the magnet sheets MS.

Then, as shown in FIG. 30B, the drawing rollers 27 are moved in the arrow direction again, and the drawing rollers 27 grasp straight or obliquely the magnet sheet MS. Then, the forefront stoppers 7 and 8 are moved in the direction of the arrow a and retracted out of the conveying path, and the drawing rollers 27 and 14 are rotated to convey the magnet sheet MS to the conveying roller 25.

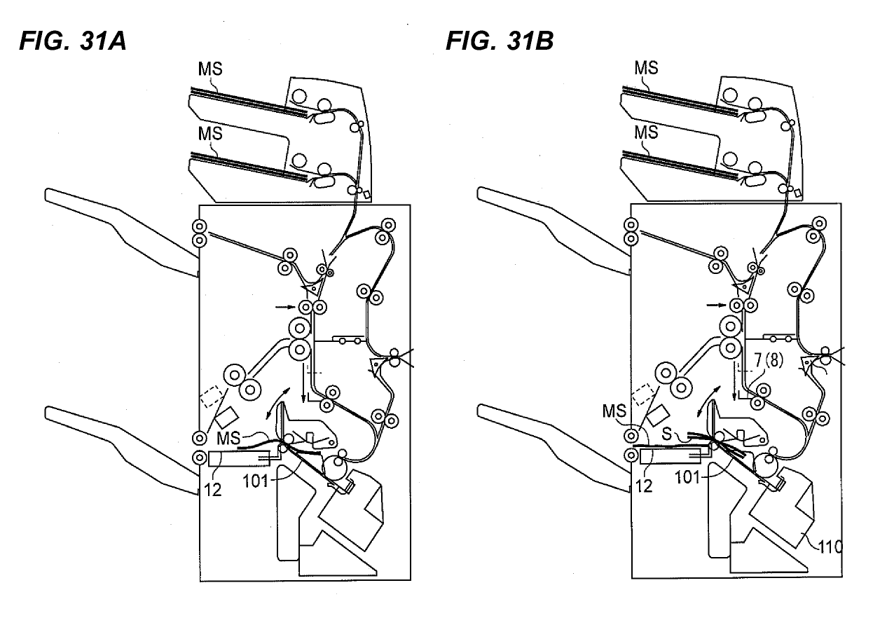

Then, as shown in FIG. 31A, the magnet sheet MS delivered to the conveying roller 25 is directly discharged onto the second processing tray 12 through the pair of sheet discharge rollers 107 and the pair of sheet-bundle discharge rollers 151. Then, as shown in FIG. 31B, the sheet S in which the image is formed is discharged on the magnet sheet MS on the second processing tray 12.

Specifically, as described above, the sheet S or sheet bundle in which the image is formed is aligned on the processing tray 101, the staple process of non-binding process is performed, and the sheet S or sheet bundle is discharged onto the magnet sheet MS by the sheet-bundle discharge roller 131.

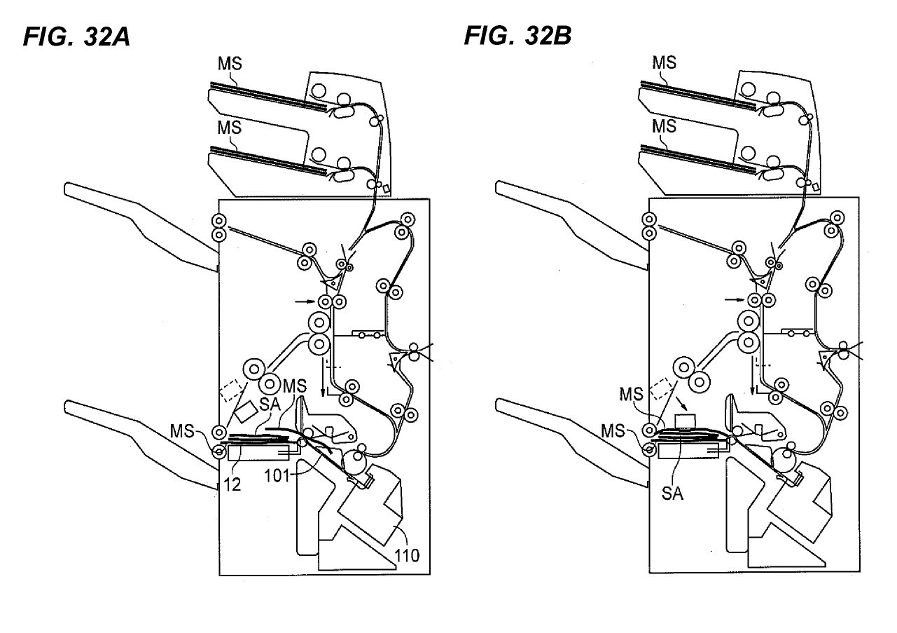

Then, as shown in FIG. 32A, the other magnet sheet MS is conveyed in the same manner as the previous magnet sheet MS. The other magnet sheet MS which becomes one of the front cover and the back cover of the product overlaps the previous magnet sheet MS which becomes the other of the front cover and the back cover of the previously discharged product. The pair of sheet-bundle discharge rollers 151 discharges the other magnet sheet MS on to the previous magnet sheet MS and sheet bundle SA which are previously stacked on the second processing tray 12.

Therefore, as shown in FIG. 32B, the sheet bundle SA is wrapped between the two magnet sheets MS. That is, the sheet bundle SA is wrapped by sequentially overlapping the other magnet sheet MS which becomes one of the front cover and the back cover and the previous magnet sheet MS which becomes the other of the front cover and the back cover.

When the security mode having the strong magnetic force is selected, CPU 60 drives the forefront stopper start-up motor 55, and CPU 60 performs control to set the forefront stoppers 7 and 8 at the same height position such that the two magnet sheets MS overlap each other while facing with the same orientation as shown in FIG. 28A.

On the other hand, when the temporarily binding mode having the weak magnetic force is selected, CPU 60 controls the positions of the forefront stoppers 7 and 8 such that the two magnet sheets MS overlap each other while the magnetic field lines overlap each other with a predetermined angle. For example, the forefront stoppers 7 and 8 are set at the same height position in the case where the first magnet sheet MS is conveyed, and the forefront stoppers 7 and 8 are set at the different height positions in the case where the second magnet sheet MS is conveyed as shown in FIG. 29A.

Thus, even in the case where the sheet is wrapped between two magnet sheets MS, the product having the strong attraction force (magnetic force) in which the N pole and the S pole attract while facing each other in parallel can be produced as shown in FIG. 28B. As shown in FIG. 29B, the product having the weak attraction force (magnetic force) can be produced by obliquely attracting the two magnet sheets MS. That is, in the case where the sheet is wrapped between the two magnet sheets MS, the products having the different attraction forces (magnetic force) can be produced according to the usage.

In the above description, the magnetization direction of one of the planes (back surface) in the magnet sheet is regulated, while the magnetization direction of the plane (front surface) on the opposite side is not regulated. Not only the first plane (front surface) of the magnet sheet MS but also the second plane (back surface) opposite side to the first plane may be regulated.

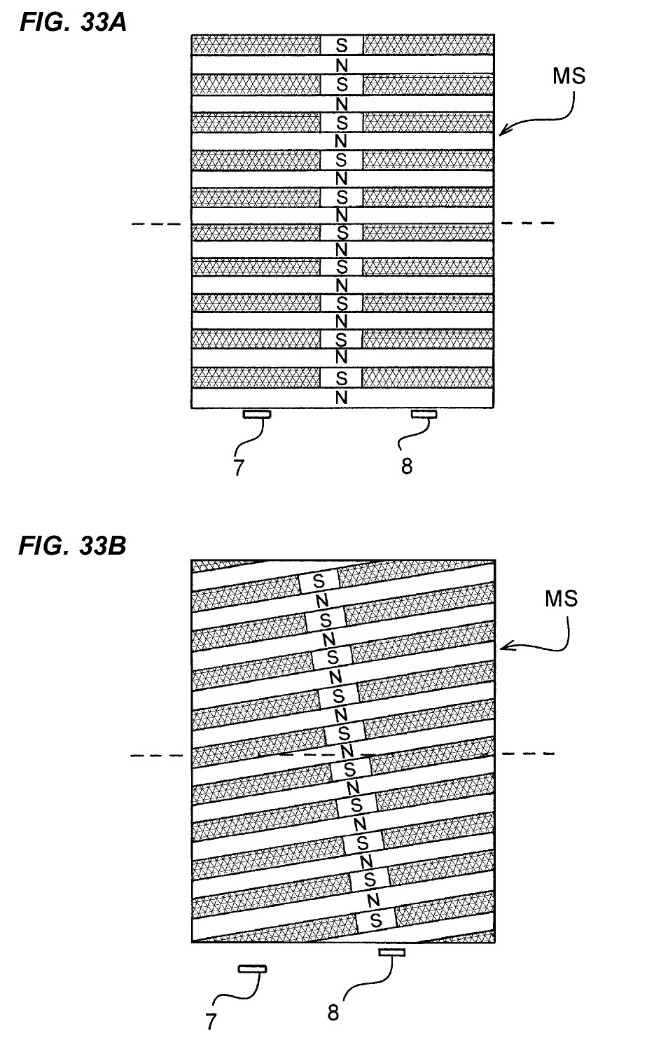

For example, the N poles and the S poles are alternately magnetized in parallel to the end face of the sheet in the front surface of the magnet sheet MS as shown in FIG. 33A, and the N poles and the S poles are alternately magnetized oblique to the end face of the sheet in the back surface as shown in FIG. 33B.

The N poles and the S poles are alternately magnetized oblique to the end face of the sheet in the back surface of the magnet sheet MS, and the magnet sheet MS simply overlap while the front surface and the back surface are regulated. Therefore, the products having the different attraction forces (magnetic forces) can be produced without inclining the magnet sheet MS.

The security process in which the magnet sheet MS is used will be described.

When the user selects the sheet folding mode which is of a mode in which the sheet bundle SA is wrapped by the magnet sheet MS without inclining the magnet sheet MS, CPU 60 (see FIG. 24) selects one of the security mode and the temporarily binding mode as described above.

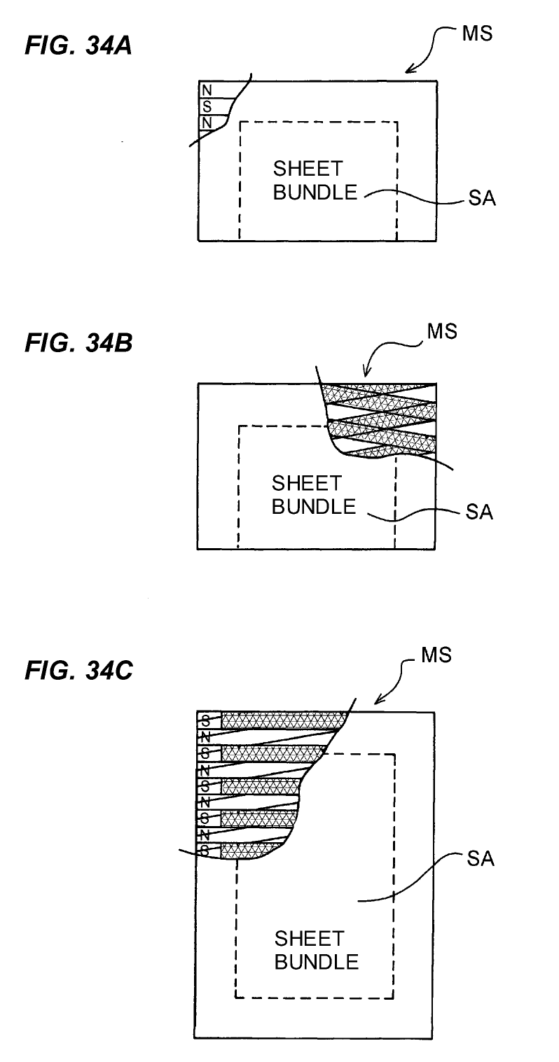

When the security mode is selected, the magnet sheet MS is folded such that the front surface of the magnet sheet MS faces inward. In such cases, as shown in FIG. 34A, the N poles and the S poles attract while facing each other in parallel, so that the product having the strong attraction force (magnetic force) can be produced.

When the temporarily binding mode is selected, the magnet sheet MS is folded such that the back surface of the magnet sheet MS faces inward. In such cases, as shown in FIG. 34B, the N poles and the S poles obliquely attract each other, so that the product having the weak attraction force (magnetic force) can be produced.

Thus, the N poles and the S poles are alternately magnetized oblique to the end face of the sheet in the back surface of the magnet sheet MS, and the front surface or back surface of the magnet sheet MS is selectively folded according to the mode, which allows the magnetic force to be changed.

The front surface or back surface of the magnet sheet MS can be regulated by previously setting the direction in which the front surface or back surface is set to the insert trays 16 and 17, when the magnet sheets MS are stacked on the insert trays 16 and 17. In the case where it is not clear whether the magnet sheet MS is stacked with the front surface or back surface up, the magnetic field line detection sensor 22 detects the orientation of the magnetic field line on the sensor surface side.

For example, in the case of the security mode, when the magnetic field line detection sensor 22 detects the oblique magnetic field line, CPU 60 (see FIG. 24) determines that the magnet sheets MS are accommodated in the insert trays 16 and 17 with the back surface up.

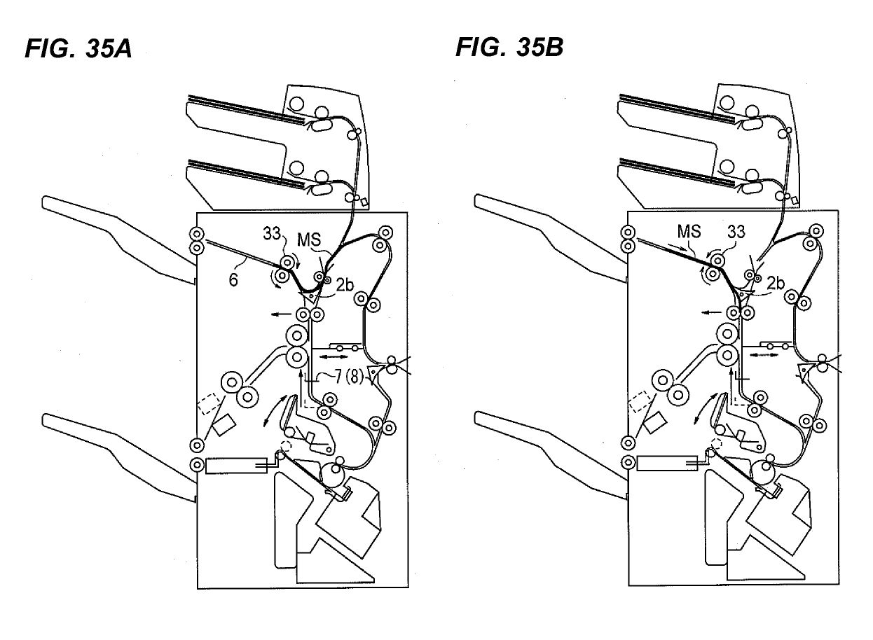

In the case where the magnet sheet MS which is accommodated back surface up is folded, the magnet sheet MS is folded such that back surface faces inward. In this case, the attraction force becomes weak. In the case where the strong attraction force is required, the magnet sheet MS is tentatively conveyed to a conveying path 6 by the changeover of the switching member 2b and the conveying roller 33 which can normally and reversely rotated as shown in FIG. 35A.

After the back end of the magnet sheet MS passes through the switching member 2b, the magnet sheet MS is conveyed in the arrow direction by the changeover of the switching member 2b and the reversal rotation of the conveying roller 33 as shown in FIG. 35B. Then, as described above, the folding roller 9 performs the folding processing and the magnet sheet MS is discharged onto the second processing tray 12. Then, the insertion portion 500G inserts the sheet S into the half-folded magnet sheet MS.

Thus, the use of the magnet sheet MS in which the front surface differs from the back surface in the magnetic field line direction can obtain the product having the strong attraction force in which the N poles and the S poles attract while facing each other in parallel as shown in FIG. 34A. As shown in FIG. 34B, the product having the weak attraction force (magnetic force) can be obtained by obliquely attracting the magnet sheet MS.

FIG. 34C illustrates an example of the product in which the magnet sheets MS overlap each other. In the magnet sheets MS of FIG. 34C, the front surface differs from the back surface in the magnetic field line direction. In this case, the magnet sheets MS overlap while one of the magnet sheets MS is reversed by the changeover of the switching member 2b and the reversal rotation of the conveying roller 33.

Therefore, the product in which the magnet sheets MS overlap with the attraction force (magnetic force) according to the usage can be obtained. The configuration of FIG. 34C eliminates the oblique folding and oblique overlapping of the magnet sheet MS, so that the aligning member can easily perform the alignment on the processing tray 101 and the second processing tray 12 to obtain the high-quality (good-alignment) product.

In the above description, the magnet sheets MS are fed from the insert trays 16 and 17. Alternatively, the magnet sheets MS may be fed from the image forming apparatus 900.

While the present invention has been described with reference to exemplary embodiments, it is to be understood that the invention is not limited to the disclosed exemplary embodiments, The scope of the following claims is to be accorded the broadest interpretation so as to encompass all such modifications and equivalent structures and functions.

This application claims the benefit of Japanese Patent Application No. 2007-253574, filed Sep. 28, 2007, which is hereby incorporated by reference herein in its entirety.

What is claimed is:

1. A sheet processing apparatus which performs a process for wrapping around a sheet with a magnet sheet having a magnetic force, the sheet processing apparatus comprising:
a wrapping portion which wraps around the sheet by bonding the magnet sheet by the magnetic force; and
a discharge portion which discharges the magnet sheet with which the sheet is wrapped.

2. The sheet processing apparatus according to claim 1, wherein the wrapping portion wraps the sheet while the magnet sheet is folded into two by a pressing force of the sheet to be wrapped.

3. The sheet processing apparatus according to claim 2, wherein the wrapping portion includes:
a support member which supports the sheet; and
a sheet conveying member which conveys the magnet sheet to a portion below the support member,
wherein a sheet end portion abuts on the magnet sheet, conveyed by the sheet conveying member, to fold the magnet sheet into two by releasing the support of the support member.

4. The sheet processing apparatus according to claim 1, wherein the wrapping portion wraps the sheet while a joining portion in which end portions of a plurality of magnet sheets are magnetically joined is folded by the pressing force of the sheet to be wrapped.

5. The sheet processing apparatus according to claim 4, wherein the wrapping portion includes:
a support member which supports the sheet; and
a sheet conveying member which conveys the plurality of magnet sheets such that the magnetically-joined end portions of the plurality of magnet sheets are located at a portion below the support member,
wherein a sheet end portion abuts on the joining portion of the plurality of magnet sheets, conveyed by the sheet conveying member, to fold the joining portion of the plurality of magnet sheets by releasing the support of the support member.

6. The sheet processing apparatus according to claim 1, wherein that the sheet is wrapped while the magnet sheet is folded into two according to at least one of size information on the sheet to be wrapped and information on the number of sheets or that the sheet is wrapped by a plurality of magnet sheets can be selected.

7. The sheet processing apparatus according to claim 1, wherein the wrapping portion includes:
a folding member which folds the magnet sheet into two;
an opening and closing portion which opens and closes an opposite end to a folding portion of the magnet sheet folded into two by the folding member; and
a conveying portion which conveys the sheet onto the magnet sheet opened by the opening and closing portion,
wherein the opening and closing portion closes the magnet sheet, opened by the opening and closing portion, to wrap around the sheet conveyed by the conveying portion.

8. The sheet processing apparatus according to claim 1, wherein the wrapping portion wraps the sheet by sequentially overlapping a magnet sheet which constitutes one of a front cover and a back cover on a magnet sheet which constitutes the other of the front cover and the back cover.

9. The sheet processing apparatus according to claim 2, wherein the magnet sheet folded into two is magnetized such that end portions on an opposite side to a folding portion of the magnet sheet are magnetically repelled.

10. The sheet processing apparatus according to claim 9, wherein a notch is formed in one of the end portions on the opposite side to the folding portion of the magnet sheet in the magnet sheet folded into two.

11. The sheet processing apparatus according to claim 4, wherein the plurality of magnet sheets are connected by a flexible member, and
in the plurality of magnet sheets, two magnet sheets located at an opposite end portion to the folding portion in wrapping the sheets are magnetized such that the end portions on an opposite side to the folding portion are magnetically repelled.

12. The sheet processing apparatus according to claim 11, wherein a notch is formed in the opposite end portion to the folding portion in one of the two magnet sheets located at the opposite end to the folding portion.

13. The sheet processing apparatus according to claim 2, wherein the wrapping portion includes an inclining member, the inclining member inclining the magnet sheet such that ends of the magnet sheet located on an opposite side to a folding portion are obliquely shifted when the magnet sheet is folded into two.

14. The sheet processing apparatus according to claim 1, wherein the wrapping portion includes an inclining member, the inclining member inclining the magnet sheet such that a plurality of magnet sheets are obliquely shifted when the plurality of magnet sheets are overlapped.

15. The sheet processing apparatus according to claim 2, wherein, in the magnet sheet folded into two, a first plane is magnetized in parallel with the folding portion of the magnet sheet,
a second plane located on an opposite side to the first plane is obliquely magnetized with respect to the folding portion of the magnet sheet, and
the wrapping portion folds the magnet sheet into two while one of the first plane and the second plane selectively faces inward.

16. The sheet processing apparatus according to claim 1, wherein, in the magnet sheet, an identification mark can be formed in an opposite plane to a plane, in which the sheet is wrapped, in order to identify the wrapped sheet.

17. An image forming apparatus comprising:
an image forming portion which forms an image on a sheet; and
the sheet processing apparatus according to claim 1 which processes the sheet on which an image is formed by the image forming portion.

18. The image forming apparatus according to claim 17, wherein the sheet processing apparatus includes a folding member, the folding member folding the magnet sheet in which an image is formed in an imageable first plane such that the first plane faces inward.

19. The image forming apparatus according to claim 18, wherein a color of the formed image is adjusted according to a color of the magnet sheet.

20. The image forming apparatus according to claim 19, wherein an image forming layer is provided in the first plane, and
a color of the formed image is adjusted according to a color of the image forming layer.

21. The image forming apparatus according to claim 20, wherein a color of the image forming layer is white or pale.

22. A sheet processing method for wrapping around a sheet with a magnet sheet having a magnetic force, the sheet processing method comprising steps of:
wrapping around the sheet by bonding the magnet sheet bonded by the magnetic force; and
discharging the magnet sheet with which the sheet is wrapped.
